(19) United States
(12) Patent Application Publication
(10) Pub. No.: US 2026/0031651 A1
(43) Pub. Date: Jan. 29, 2026

(54) ELECTRIC VEHICLE SMART CHARGING CABLE ADAPTER SYSTEMS AND METHODS

(71) Applicant: Orange Charger Inc., Menlo Park, CA (US)

(72) Inventors: Nicholas George Johnson, III, Menlo Park, CA (US); Volker Schönefeld, Cologne (DE); Neil Joseph, Redwood City, CA (US)

(21) Appl. No.: 19/279,173

(22) Filed: Jul. 24, 2025

Related U.S. Application Data
(60) Provisional application No. 63/675,788, filed on Jul. 26, 2024.

(51) Int. Cl. H02J 13/00; B60L 53/16; B60L 53/65; G06Q 20/40; G06Q 50/06

(52) U.S. Cl. CPC H02J 13/0005; B60L 53/16; B60L 53/65; G06Q 20/401; G06Q 50/06; H02J 13/00001; H02J 13/00022

(57) ABSTRACT

An electric vehicle charging system is configured for performing user authorization, authentication, and billing. The electric vehicle charging system comprises an outlet assembly electrically connected to a smart plug equipped with circuitry including a communication tag. The communication reader of the outlet assembly detects the connected smart plug and pairs with its communication tag using any type of near field communication when signaled, facilitating communication. Additionally, an aggregated charging controller, in communication with a server, generates a unique identifier associated with the cable. The server, utilizing a power distribution engine, distributes power to the charger upon verifying the authenticity of the cable's identifier and confirming the pairing between the communication tag reader of the outlet assembly and the communication tag of the smart plug.

### CROSS-REFERENCE TO RELATED APPLICATIONS

This application is a U.S. Non-Provisional Utility Patent Application entitled, “Electric Vehicle Smart Charging Cable Adapter Systems and Methods” which claims priority to co-pending U.S. Provisional Patent Application No. 63/675,788, filed on Jul. 26, 2024 entitled, “SMART PLUG CHARGING SYSTEM” the contents of which are hereby fully incorporated by reference.

### FIELD OF THE EMBODIMENTS

The present disclosure relates to smart plug-based electric vehicle charging systems that incorporate near-field communication, sensor technologies, and server-based authentication for secure power delivery. More particularly, the embodiments pertain to systems and methods for verifying user identity, managing dynamic identifiers, and controlling charging access and billing without requiring a dedicated mobile application.

### BACKGROUND

Typically, electric vehicle (EV) charging systems need help with problems that hinder their efficiency and user satisfaction. One issue is the need for additional repeaters and networking infrastructure to ensure connectivity, particularly in challenging environments such as underground parking garages where Wi-Fi and cellular signals are weak and/or non-existent. This not only increases the installation and operational costs but also requires constant maintenance and updates to keep the network functional. Furthermore, many EV charging systems rely on Wi-Fi or cellular signals to operate, which can be unreliable. EV owners typically have mobile cables provided with their vehicles, but these cables are prone to frequent breakdowns and are expensive to repair. This results in downtime where residents must wait for repairs before they can resume charging their vehicles, causing inconvenience and frustration. Adding to the complexity, because there is no standard cable connection for charging EVs, different vehicles often require different types of connectors. This necessitates the development and provision of adapters for each cable type or connector type, further increasing the cost and complexity of EV charging infrastructure. Users may find it cumbersome to manage multiple adapters, and the lack of standardization can lead to compatibility issues, preventing seamless charging experiences.

Additionally, the reliability of many EV charging systems is questionable, with frequent maintenance required to keep them operational. This unreliability, coupled with the need for regular repairs, further diminishes user trust and satisfaction. Another financial burden for users is the fixed monthly fee per charger, regardless of how much a charger is used. This fee structure can be costly and inefficient, especially for those who do not charge their vehicles frequently, leading to dissatisfaction among users who feel they are not getting their money's worth. Many of these issues highlight the need for more reliable, cost-effective, and user-friendly EV charging solutions that can operate efficiently in various environments and reduce the financial and operational burdens on users.

### SUMMARY OF THE INVENTION

A smart plug system includes a smart plug that can be removably connected to one or more loads and electrically connected to a power source linked to a charging station. The smart plug features circuitry with a near-field communication protocol, comprising a communication tag with a transceiver for signal transmission to a communication tag reader at the charging station. Additionally, the system includes a cellular modem with a transceiver connected to a server, a financial transaction verification processor linked to the server, and an aggregated charging controller connected to the server. The aggregated charging controller generates a first identifier associated with the smart plug, enabling efficient and secure communication and control within the smart plug system.

In some aspects, the techniques described herein relate to a smart plug, including: the smart plug is configured to be removably connected to one or more loads; the smart plug is configured to be electrically connected to a power source, the power source is configured to be electrically connected to a charging station; and circuitry including: a near-field communication protocol, including: a communication tag, the communication tag of the smart plug has a transceiver configured to electronically communicate a signal to a transceiver of a communication tag reader of the charging station; a cellular modem, the cellular modem has a transceiver in electrical communication with a server; a financial transaction verification processor electrically connected to the server; an aggregated charging controller, the aggregated charging controller is electrically connected to the server, and wherein a first identifier is generated by the aggregated charging controller and is associated with the smart plug.

In some aspects, the techniques described herein relate to a smart plug, further including: one or more data storage is electrically connected to the server, the one or more data storage including: a power distribution engine, wherein the server is configured, by the power distribution engine, to distribute power to the charging station in response to verifying, based on proximity of the smart plug to the charging station, by the aggregated charging controller, authenticity of the first identifier of the smart plug and identifying a pairing of the communication tag reader of the charging station with the communication tag of the smart plug and verifying at least one financial transaction at the financial transaction verification processor.

In some aspects, the techniques described herein relate to a smart plug, wherein the aggregated charging controller generating a second identifier, the second identifier is configured to dynamically replace the first identifier after the first identifier is verified, wherein the second identifier is different than the first identifier, and the first identifier and the second identifier are based on one or more environmental parameters.

In some aspects, the techniques described herein relate to a smart plug, further including: an electronic device, the electronic device having a display, the display having a graphic user interface, the electronic device having a communication tag reader configured to pair with the communication tag of the smart plug to establish connection between the electronic device and the server.

In some aspects, the techniques described herein relate to a smart plug, further including: the smart plug having one or more sensors, the server is configured to receive authentication data from the one or more sensors, wherein the server analyzes the authentication data to indicate a user status as being registered or unregistered, responsive to indicating the user status being registered, authorizing the server to distribute power from the charging station to the one or more loads, thereby allowing unrestricted operation of the charging station, and responsive to indicating the user status being unregistered, authorizing the server to distribute the power from the charging station to the one or more loads, thereby allowing restricted operation of the charging station.

In some aspects, the techniques described herein relate to a smart plug, wherein the authentication data includes image recognition of a user and of the one or more loads.

In some aspects, the techniques described herein relate to a smart plug, wherein the authentication data includes geolocation and time information.

In some aspects, the techniques described herein relate to a smart plug, wherein the one or more sensors being a camera, the camera is configured to detect an electric vehicle identifier, wherein the server pairs the electric vehicle identifier with a user account to validate the user status as being registered if the electric vehicle identifier matches with a registered electric vehicle identifier associated with a profile of a registered user.

In some aspects, the techniques described herein relate to a smart plug, wherein the one or more sensors being a communication tag reader electrically connected to the server, the communication tag reader is configured to detect an electric vehicle communication tag when a signal of the electric vehicle communication tag is transmitted, using a transmitter of the electric vehicle communication tag, to a transceiver of the communication tag reader, wherein the server is configured to pair the electric vehicle communication tag with a user account to validate the user status as being registered if the electric vehicle communication tag matches with a registered electric vehicle communication tag associated with a profile of a registered user.

In some aspects, the techniques described herein relate to a smart plug, wherein the restricted operation of the charging station being a single use access having a predetermined length of time.

In some aspects, the techniques described herein relate to a smart plug, wherein the restricted operation of the charging station being access to a graphic user interface of a display of the charging station, the graphic user interface of the display is configured for an unregistered user to input profile data to be processed by the server to update the user status as registered.

In some aspects, the techniques described herein relate to a smart plug, wherein the restricted operation of the charging station being access to a graphic user interface of a display of an electronic device, the graphic user interface of the display is configured for an unregistered user to input profile data to be processed by the server to update the user status as registered.

In some aspects, the techniques described herein relate to a charging assembly, including: a cable with a first end, the first end of the cable is configured to connect to a charger, the cable having a second end; an adapter at the second end of the cable configured to connect to one or more loads, the cable is configured to provide power to the one or more loads from the charger; circuitry disposed at a portion of the charging assembly, the circuitry including: an identification processor, the identification processor having a router including a communication tag; and a cellular modem, the cellular modem having a transceiver in electrical communication with a server; a financial transaction verification processor is electrically connected to the server; and wherein the cable is coupled to the one or more loads and is configured to be detected by a communication tag reader of the charger and paired with the communication tag of the charging assembly when a signal of the communication tag is transmitted, using a transmitter of the communication tag, to a transceiver of the communication tag reader.

In some aspects, the techniques described herein relate to a charging assembly, further including: a router is configured to be in electrical communication with a network coordinator, wherein the router having a dynamic address generated by the network coordinator, the dynamic address of the router is configured to be associated with a first media access control address of the identification processor of the cable, by the network coordinator, wherein the first media access control address is configured to associate a registered user of the cable with the one or more loads.

In some aspects, the techniques described herein relate to a computer-implemented method including: providing an aggregate charging server; providing an electronic device, the electronic device is in electrical communication with the aggregate charging server; providing a charging station, including: a remote monitoring processor having a transceiver, the remote monitoring processor including a network coordinator electrically connected to a gateway; providing a cable having an identification processor, wherein the identification processor having a router in electrical communication with the network coordinator; assigning the router a dynamic address, by the network coordinator; associating the dynamic address of the router with a first media access control address of the identification processor of the cable, by the network coordinator, and wherein the first media access control address associating a registered user of the cable with an electric vehicle; monitoring for a presence of the electric vehicle connected to the charging station with the cable, by the aggregate charging server; responsive to detecting the presence of the electric vehicle connected to the charging station with the cable, by the aggregate charging server, initializing the network coordinator; detecting, by the network coordinator, the presence of the first media access control address of the identification processor of the cable, transmitting, by the aggregate charging server, a charging station command to identify the charging station the electric vehicle is connected to; transmitting, by the aggregate charging server, a registration command to authenticate the detected first media access control address of the identification processor of the cable as being registered to a user having a registration status being active or inactive, wherein transmitting, by the aggregate charging server, an enable charging command to activate charging of the electric vehicle if the registration status of the user is active;

In some aspects, the techniques described herein relate to a computer-implemented method, wherein responsive to transmitting the enable charging command, replacing by the network coordinator, the first media access control address of the identification processor of the cable with a second media access control address when the first media access control address has been authenticated, the second media access control address is different from the first media access control address.

In some aspects, the techniques described herein relate to a computer-implemented method, further including: transmitting, by the aggregate charging server, a first new user command to activate charging of the electric vehicle for a predetermined length of time if the registration status of the user being a first-time user is inactive.

In some aspects, the techniques described herein relate to a computer-implemented method, further including: transmitting, by the aggregate charging server, a second new user command to activate a user interface on a display of the electronic device if the registration status of the user being an existing user is inactive, wherein prompting the existing user to update the registration status to active.

In some aspects, the techniques described herein relate to a computer-implemented method, further including: transmitting, by the aggregate charging server, a second new user command to activate a user interface on a display of the charging station if the registration status of the user being an existing user is inactive, wherein prompting the existing user to update the registration status to active.

In some aspects, the techniques described herein relate to a computing device to implement an app-less process for authentication and charging access within a smart plug charging system, including: a memory circuit storing computer executable instructions; and a processing device, wherein execution of the computer executable instructions by the processing device, causes the processing device to: generate a first identifier to identify an adapter registered by the smart plug charging system; authenticate the first identifier, based on proximity of the adapter to a charging station; and generate a second identifier, the second identifier is configured to dynamically replace the first identifier after the first identifier is verified, and wherein the second identifier is different than the first identifier; responsive to verification, activate a charging session if at least one financial transaction is verified by a financial transaction verification processor.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example of an infrastructure for the smart plug charging system with a smart plug implemented at an outlet assembly for EV charging in accordance with some embodiments.

FIG. 2 is a rear perspective view of the smart plug of FIG. 1 in accordance with some embodiments.

FIG. 3 is a front perspective view of an outlet assembly electrically connected to the smart plug of FIGS. 1 and 2 in accordance with some embodiments.

FIG. 4 is a diagram of an example app-less adapter process implemented at the smart plug charging system of FIG. 1 in accordance with some embodiments.

FIG. 5 is a diagram of an example process to facilitate secure communication and operation of EV chargers and/or outlets using the smart plug of FIG. 1 implemented at the outlet assembly for device charging in accordance with some embodiments.

FIG. 6 is a block diagram illustrating an embodiment of a smart plug comprising circuitry that includes a near-field communication protocol, in accordance with some embodiments.

FIG. 7 is a block diagram illustrating a smart plug comprising circuitry and data storage, the data storage including a power distribution engine configured to instruct a server to distribute power to a charging station upon verification of a first identifier, confirmation of communication tag pairing, and validation of a financial transaction, in accordance with some embodiments.

FIG. 8 is a block diagram illustrating a smart plug comprising circuitry including an aggregated charging controller configured to generate a second identifier based on one or more environmental parameters, the second identifier replacing a first identifier after verification, in accordance with some embodiments.

FIG. 9 is a block diagram illustrating a smart plug comprising circuitry with a near-field communication protocol, one or more sensors configured to collect authentication data, and a server configured to analyze the authentication data to determine a user status, in accordance with some embodiments.

FIG. 10 is a block diagram illustrating a smart plug comprising circuitry with a near-field communication protocol, one or more sensors including a camera and a communication tag reader, and authentication data comprising geolocation and time information, in accordance with some embodiments.

FIG. 11 is a block diagram illustrating a smart plug comprising circuitry and one or more sensors configured to support restricted operation of a charging station, wherein the restricted operation corresponds to a single-use access session having a predetermined length of time, in accordance with some embodiments.

FIG. 12 is a block diagram illustrating a charging assembly comprising a cable with a first end configured to connect to a charger and a second end connected to an adapter for delivering power to one or more loads, in accordance with some embodiments.

FIG. 13 is a block diagram illustrating a charging assembly comprising a cable, adapter, circuitry, a cellular modem, a financial transaction verification processor, and an identification processor having a router configured to receive a dynamic address from a network coordinator, in accordance with some embodiments.

FIGS. 14A and 14B collectively illustrate a flowchart of a computer-implemented method for authenticating and enabling electric vehicle charging, in accordance with some embodiments.

FIG. 15 is a flowchart illustrating an embodiment of a computer-implemented method wherein, if the registration status of the user is inactive, the aggregate charging server transmits a second new user command to activate a user interface on a display of an electronic device, in accordance with some embodiments.

FIG. 16 is a flowchart illustrating an embodiment of a computer-implemented method wherein, if the registration status of a user is inactive, the aggregate charging server transmits a second new user command to activate a user interface on a display of the charging station, in accordance with some embodiments.

FIG. 17 is a flowchart illustrating an embodiment of a computing device configured to implement an app-less authentication and charging access process within a smart plug charging system, in accordance with some embodiments.

### DETAILED DESCRIPTION

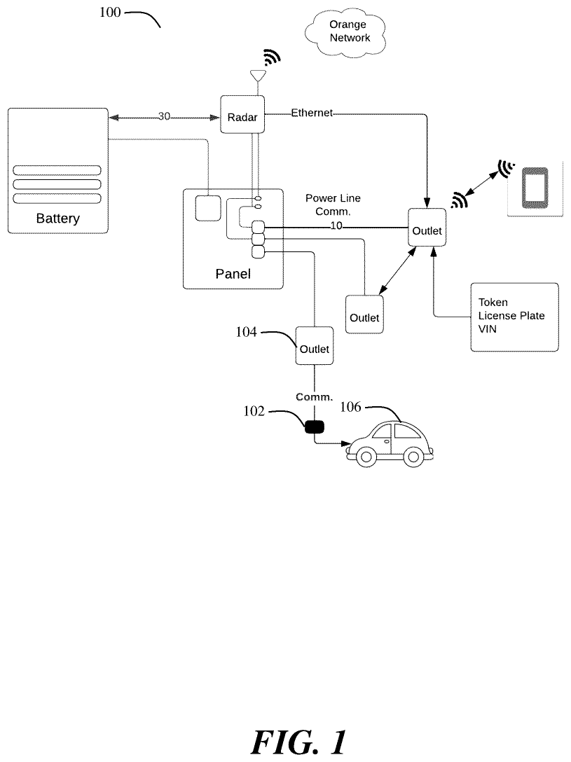

FIGS. 1-17 illustrate example configurations, structures, and processes to implement a smart plug, configured for EV charging, at an EV charging system. The smart plug may be used for any connected outlets and has circuitry and software configured for charging vehicles. For example, the circuitry of the EV charging system is retained within a housing and is configured to accurately track energy usage, control power, manage access, and connect to the internet. Each smart plug may include one or more advanced communication technologies to enhance its functionality and integration with other devices. These technologies include, but are not limited to, Bluetooth, Wi-Fi, a cellular modem, sub-1 GHz or similar long-range RF capabilities, and near-field communication (NFC). For example, Bluetooth enables short-range, low-power communication, making it ideal for quick and easy device pairing and data exchange within a close proximity. Wi-Fi provides high-speed internet connectivity, allowing the smart plug to connect to a local network and communicate with other smart devices or cloud services over a larger area. A cellular modem allows the smart plug to connect to the internet via mobile networks, ensuring reliable connectivity even when traditional Wi-Fi networks are unavailable, such as in remote locations. Sub-1 GHz or similar long-range RF capabilities enable the smart plug to communicate over longer distances and through obstacles more effectively than higher-frequency signals, making it suitable for expansive or challenging environments. NFC facilitates secure, contactless interactions at very close range, allowing for quick and secure data exchange or device authentication. By incorporating these diverse communication technologies, the smart plug can offer enhanced software features, improved connectivity, and greater versatility in various use cases. Unlike other chargers and connected plugs, this EV charging system is fundamentally designed to meet the performance requirements of EV environments and use cases.

The smart plug, configured for EV charging, may have circuitry retained within a cable and/or an adapter. The circuitry integrates seamlessly into the control and software platform, automatically starting and stopping charging sessions and tracking user sessions. The smart plug, designed with a software-defined architecture, offers a versatile and intuitive user experience. Traditionally, users can configure and manage their accounts through a web portal or a mobile app, providing convenience and accessibility from various devices. However, as technology continues to evolve, the integration of smart plugs is expected to expand beyond these conventional platforms. For instance, future advancements may enable users to set up and control their smart plugs directly from their vehicles, leveraging the connectivity features of modern cars. This would allow users to manage their home devices seamlessly while on the go, enhancing the convenience and functionality of smart home ecosystems.

Moreover, the advent of augmented reality (AR) technology presents another exciting possibility. With AR glasses, users could interact with their smart plugs through a more immersive and intuitive interface. This could involve visualizing the status of various devices within their home environment, receiving real-time alerts, and even performing setup and adjustments through simple gestures and voice commands. The integration of AR could revolutionize the way users interact with their smart home devices, making the process more engaging and efficient.

Each smart plug is assigned an identifier on the platform with user-defined permissions. The smart plug can automatically start and stop EV charging sessions on authenticated devices and includes location tracking. Users can suspend, reactivate, or mark the cable as lost within the software. Electrical communication between the cable and/or adapter of the smart plug and the charging device can occur through Bluetooth low energy (BLE), Wi-Fi, NFC, and/or other wireless or hardware-designed data links, ensuring the device recognizes its unique ID and the user associated with each charging session.

FIG. 1 illustrates an example diagram of Electric Vehicle Supply Equipment (EVSE) for a smart plug charging system 100. EVSE is the infrastructure for supplying electric power to charge the EV 106 and includes a charging station, which serves as the point of connection for the EV 106, and associated equipment necessary for linking the charging station to the electric grid. The components of the EVSE for the smart plug charging system 100 include the charging station itself, which may be an outlet assembly 104, the smart plug 102 which electrically connects the EV 106 to the outlet assembly 104, and the control and communication equipment which are responsible for managing the charging process.

The smart plug charging system 100 is configured for storing forward. In an example, when the network is not connected to the cloud, a registered user will have the ability to use the smart plug 102 with the EV charger and/or at the outlet assembly 104, offline, to charge the EV 106. Each outlet assembly 104 incorporates the capability to create a Wi-Fi mesh network, thereby extending its range to cover areas such as parking garages. This feature enhances connectivity and accessibility, ensuring that EV owners can access charging infrastructure even in locations where traditional Wi-Fi coverage may be limited and/or unreliable. By creating a mesh network, each outlet assembly 104 acts as a node that communicates with neighboring nodes, effectively expanding the coverage area, and improving signal strength throughout the parking facility. This enables EV owners to easily locate and access charging stations, monitor charging sessions remotely, and receive real-time notifications about charging status, all while enjoying seamless connectivity within the parking garage.

In other words, a registered user may be able to charge their vehicle offline and receive a bill associated with the charging at a later time. In particular, after completing a two-step or dual key authentication process, with a first and second identifier of the smart plug 102, the registered user will be authorized to charge their vehicle without being required to complete a payment transaction. It is within the scope of this invention for the smart plug 102 to have a dual key authentication process involving a first identifier configured for enhanced cyber security and a second dynamic identifier configured for anti-spoofing applications. Further, the smart plug 102 is recoded with an updated/different second identifier every connection, such as when the cable is in communication with a local router. The second dynamic identifier changes every time the EV is subsequently charged because a new random dynamic identifier is generated and replaces the second identifier. Authentication data of a user, the smart plug 102, the outlet assembly 104, and the EV 106, such as geographical coordinates, may be authenticated without the system being connected to the cloud, but by a location of an EV charger. For example, authentication data may be downloaded to a local router of the EV cable when the cloud is not available.

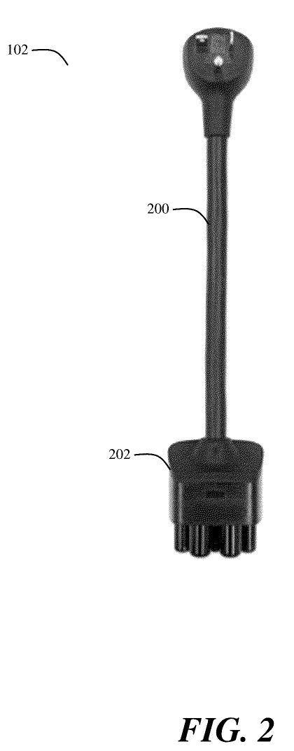

FIG. 2 illustrates the smart plug 102 of FIG. 1 that implements charging of the EV 106 at the smart plug charging system 100 of FIG. 1. The device includes a charging cable 200 and/or an adapter 202 of the smart plug 102 constitute components in the smart plug charging system 100, facilitating the connection between the EV 106 and the charging infrastructure. The charging cable 200 serves as the physical conduit, linking the charging station or outlet assembly 104 to the EV's charging port. The adapter 202, also known as the connector or plug, acts as the intermediary between the EV's charging port and the charging cable 200, ensuring a secure and reliable electrical connection.

The smart plug charging system features a smart plug equipped with the communication tag reader designed to detect the cable connected to the loads. This communication tag reader pairs with a transmitter of a communication tag embedded in the cable and/or adapter of the smart plug when a signal is transmitted from the communication tag to the communication tag reader, facilitating secure and efficient communication between the charger and the cable. Additionally, the system incorporates an aggregated charging controller that communicates with a server. This aggregated charging controller generates a unique identifier associated with the cable, which is utilized to verify the authenticity of the cable. The server, equipped with a power distribution engine, then distributes power to the charger based on the verified identifier and the pairing of the communication tag reader with the communication tag. This integrated approach enhances power distribution and management in charging systems, ensuring efficient and reliable charging processes while maintaining security and authenticity.

In implementations, to verify a financial transaction within a smart plug system to activate a charge, a systematic multi-step process involving communication and interaction between the smart plug, the charging station, and the server may be facilitated. Initially, the smart plug is connected to one or more loads and a power source, with the power source linked to the charging station. Once powered on, the smart plug and the charging station are configured to be operational and capable of communication. The process begins with the near-field communication (NFC) tag chip in the smart plug being activated upon connection to the charging station. The NFC transceiver within the smart plug then transmits a signal containing a unique identifier and relevant transaction data to the communication tag reader in the charging station. Subsequently, the cellular modem in the smart plug establishes a connection with the server and transmits the identifier and/or transaction data. Upon receiving this information, the server undertakes a verification process, where it cross-checks the identifier against stored data to confirm the authenticity of the smart plug and the legitimacy of the transaction. Power is distributed to the smart plug when both the authenticity of the smart plug and validation of the payment method are authenticated. In embodiments, the authentication may be based on one more predetermined environmental parameters such as the transaction amount, time, and/or location. The server then communicates the outcome of this verification process back to the smart plug via the cellular modem, and, if necessary, to the charging station through its connection to the aggregated charging controller. Finally, the smart plug and/or charging station may display the transaction status, indicating whether it has been approved or denied. If approved, the server processes the payment and completes the financial settlement. This procedure ensures that each charge employed through the smart plug is authenticated, one or more financial transactions verified, and accurately recorded, thereby maintaining the integrity and security of the system.

As noted above, the server itself is equipped with a financial transaction verification processor that authenticates transactions by cross-referencing one or more unique identifiers and transaction details against stored data. This server houses a database for storing transaction data, user accounts, and verification parameters, along with a communication interface for data transmission to and from the smart plug and charging station, and a payment processing gateway to finalize financial transactions upon verification. In implementations, a financial transaction may be verified by a financial transaction verification processor, contingent upon the availability of sufficient monetary funds to cover the charge service at the charging station. For instance, if a user has a credit card linked to their account, the system can automatically check the card's validity and available credit before approving the transaction. Alternatively, the system may verify that prepayment funds and/or credits have been deposited and are available for use. For example, a user might have prepaid a specific amount into their account, which the system will draw from to pay for the charging service. This verification process ensures that transactions are approved or declined based on the immediate availability of funds, thereby facilitating smooth and reliable financial operations within the system.

In implementations, the communication of the smart plug charging system is facilitated using a coil and an NFC chip embedded at one or more portions of the smart plug. This NFC chip contains user-specific information, similar to the token assigned to the user's phone, but integrated into the cable itself. To establish communication, the NFC chip needs to be within a range of 4-5 inches from the reader. Information is injected into the NFC chip at the time of manufacturing, ensuring that each individual cable possesses a unique identifier. Alternatively, users can pair their phones with the cable by scanning it, enabling transmission of their token either directly from the phone or via Bluetooth. This token allows users to access the cable as if it were an extension of their phone, transmitting their identity to the device for later use. Furthermore, the system dynamically adapts to network availability, allowing users to connect even when network access is unavailable. Moreover, users are empowered to conduct transactions based on trust, enabling them to charge their EVs even when out of network and settle the payment later. Integration with a router connection enables the collection of power-related data, providing valuable insights into power consumption and usage patterns.

As noted, in at least one embodiment, incorporating Bluetooth communication into the system involves integrating a Bluetooth chip within the smart plug. This chip facilitates wireless communication between the plug and other devices, enabling seamless interaction and data exchange. Bluetooth operates using specific communication protocols, such as Bluetooth Low Energy (BLE) or Bluetooth Classic, each serving distinct purposes. For instance, BLE is well-suited for transmitting small amounts of data with minimal energy consumption, making it ideal for applications like device pairing and data synchronization. On the other hand, Bluetooth Classic supports higher data transfer rates, making it suitable for audio streaming and file sharing. By implementing Bluetooth connectivity, users can interact with the smart plug using their mobile devices or other Bluetooth-enabled devices, enabling convenient control and monitoring of charging processes.

Further, in implementations, active device authentication involves the system authenticating devices using a secret token. This process relies on a passive C microchip embedded within the device, equipped with a processor to handle authentication tasks. The microchip contains data that requires authentication, which can only be modified or accessed using a unique private key, referred to as the “Orange key.” Each outlet within the system possesses its own distinct Orange key, which can be periodically rolled to enhance security. Similar to how device authentication is currently managed on a user's phone, where tokens are rolled once a month, the same approach can be applied to the cable. Users would pair their cable with their phone at least once a month by tapping the cable to the phone, initiating the authentication process. In this manner, users can ensure that the system recognizes and authenticates the cable, providing a secure connection for charging. Additionally, the token associated with the cable would expire monthly, further bolstering security measures against unauthorized access or copying of the cable's authentication data.

The implementation of image authentication and charging access within the EV charging system enables EVs to communicate with smart plugs and outlet assemblies using standards such as the ISP 1511, for example. However, only a limited number of vehicles currently possess this connectivity capability. To address this limitation, leveraging camera and/or other imaging technologies for authentication and charger access emerges as a superior solution. Once a user or vehicle is within the Orange network, their identity is established, eliminating the need for repeated setup within the network. Periodic revalidation may be necessary to maintain security measures. The CMOS sensor facilitates the authentication process by cross-referencing data obtained from both the vehicle and the charging plug. This dual verification approach ensures more accurate authentication of connected cables and vehicles, doubling the authentication process without requiring user intervention. Furthermore, the system can authenticate data from the vehicle itself, provided the vehicle is equipped with the necessary capabilities, though not all vehicles may possess this feature.

In addition to traditional camera-based imaging technology, other advanced imaging technologies can be utilized for authentication and charger access within the EV charging system. One such technology is LiDAR (Light Detection and Ranging), which uses laser pulses to measure distances and generate precise 3D maps of surrounding objects. LiDAR can be employed to accurately detect and identify vehicles and objects in the charging area, enhancing security and authentication measures. Another example is infrared imaging, which captures heat signatures emitted by objects. Infrared imaging can be used to detect the presence of vehicles or individuals in low-light conditions or obscured environments, providing an additional layer of authentication and safety. Additionally, depth sensing technology, such as structured light or time-of-flight cameras, can be utilized to create detailed depth maps of the charging area, enabling precise positioning and authentication of vehicles and charging equipment.

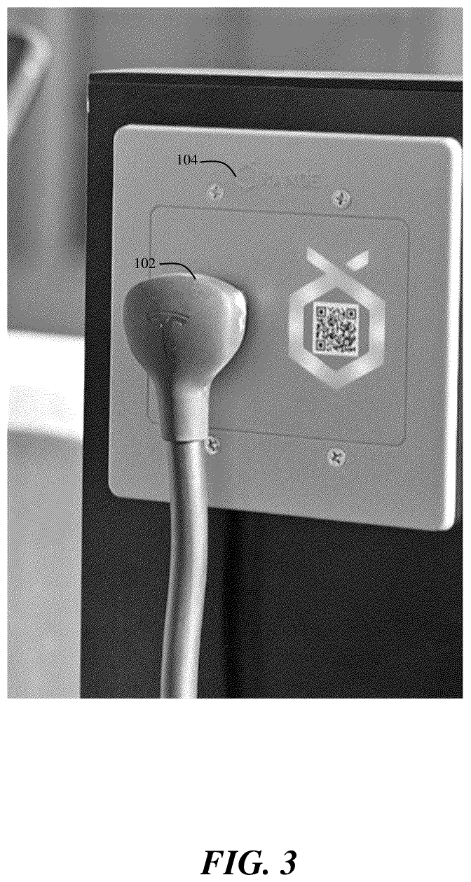

The smart EV charging system integrates a charging algorithm and authentication mechanism to streamline the charging process while ensuring security and user convenience. For example, if a user exhibits regular charging behavior within a reasonable timeframe, authentication may not be required for subsequent charging sessions, assuming it aligns with their typical patterns (e.g., regular commute, habitual locations). The system employs a straightforward algorithm, primarily based on factors such as proximity, charging frequency, and habitual travel destinations, to quickly ascertain user behavior and charging patterns over various timeframes-weekly, monthly, and annually. By analyzing this data, deviations from normal behavior can be promptly identified. When the system detects an anomaly or deviation from the user's typical charging behavior, it may interrupt the charging session and prompt the user for authentication. This authentication process can involve various methods, such as requiring the user to present their phone for verification or requesting authorization via text message. By implementing these authentication measures, the system ensures that charging activities remain secure and in line with user expectations, minimizing the risk of unauthorized access or misuse. The smart plug 102 employs an example of a first portion of the smart plug 102 electrically connected to the outlet assembly 104, as shown in FIG. 3.

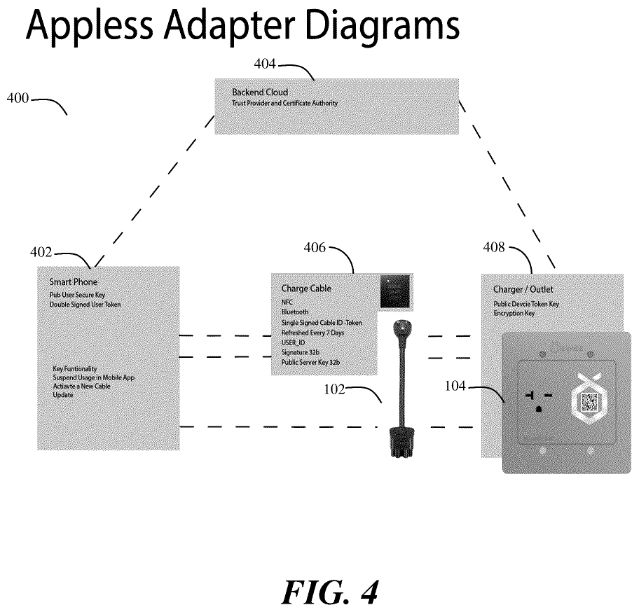

FIG. 3 illustrates the outlet assembly 104 electrically connected to the smart plug 102 of FIGS. 1 and 2. In implementations, the smart EV charging system incorporates a genuine adapter cable feature to ensure security and authenticity during charging sessions. This cable of smart plug 102 is compatible with the smart charging system's charging devices, also referred to as, Orange's charging devices, allowing the system to verify its origin and authenticity. The system can identify unauthorized and/or counterfeit cables and prevent charging sessions from proceeding. The smart EV charging system integrates an identity provider for IoT networks, enabling secure access control and authentication processes for charging sessions, supported by “app-less” adapters and peer-to-peer communication technologies as shown in FIG. 4.

FIG. 4 illustrates an example app-less adapter process 400 implemented at the smart plug charging system of FIG. 1. The smart plug 102 is electrically connected to outlet assembly 104. At block 402, an electronic device such as a tablet, a smart phone, and/or a computer may be in wired and/or wireless communication with the smart plug 102 and a backend cloud. At block 404, a back-end cloud is configured for trust provider and certificate authority, which is in communication with an electronic device and the charger outlet. The electronic device, at block 402, is configured to support a public user secure key, double-signed user token, and other functionalities of a smartphone, including suspending usage within a mobile app to activate a new cable or perform updates. At block 406, the charge cable may be configured with an NFC, Bluetooth, and/or single-signed cable ID token, which refreshes at predetermined intervals, such as every seven days. In implementation, the charge cable also includes a user ID, a 32-byte signature, and/or a 32-byte public server key. The charge cable maintains electrical communication with the charger outlet. As described in block 408, the charger outlet is equipped with a public device token key and an encryption key.

The smart EV charging system incorporates an identity provider for IoT networks to manage access control for internet-connected devices, enabling functionalities such as payments and user identifications to determine authorization for actions like initiating charge sessions or accessing doors. However, existing solutions relying on passive RFID cards or smartphone apps often exhibit unreliability due to various factors. To address this, the system, also known as, Orange, developed a platform capable of utilizing active mobile devices equipped with a specific app to enforce security measures offline. This platform generates one or more rotating tokens and/or identifiers from the backend when connected, ensuring ongoing payment verification and access authorization. Additionally, the system aims to introduce “app-less” adapters or smart adapters to streamline the charging process without requiring users to repeatedly use their mobile devices. These adapters can be paired with a user's account using a set of instructions on a mobile device, enabling seamless authentication and access to OrangeNet services. In implementations, the first identifier and the second identifier are based on one or more environmental parameters including, but not limited to, a specific vehicle, time, and/or location.

As noted above, key features of this identity provider system include the ability to authenticate sessions and process payments solely through the adapter cable, utilizing dynamic rotation keys assigned to specific user accounts. Moreover, since adapters are authenticated by user accounts, account transfers or changes can be easily accommodated without requiring reactivation. The system also supports local authentication without reliance on cloud connectivity, with updates synchronized to the cloud when available. Peer-to-peer communication, employing NFC and BLE technologies, facilitates data exchange between devices, enabling secure authentication processes. The system supports various connection types, including wired, wired over power, and wireless, such as broadband connections, catering to diverse charging scenarios. The adapters, akin to mobile applications, are capable of being managed through software, enabling actions like activation, deactivation, suspension, and deletion from user accounts. Additional features include signaling messages to account payees, allowing internal identity modification, and the potential integration of trusted platform module (TPM) chips for generating protected unique identifiers. A normal time window for usage and secondary confirmation requirements enhance security further. Given their capability to start and stop charge sessions, adapters are treated like digital credit cards within OrangeNet, facilitating payments and access based on established standards. Overall, the identity provider system enhances security, reliability, and user convenience within the smart EV charging ecosystem, ensuring access control and authentication processes.

As noted above, the smart EV charging system implements tokens such as one or more identifiers, store and forward mechanisms, and a single clearinghouse to address various challenges, particularly stranded asset issues. With a multi-Path data system, data transmission is optimized through multiple pathways, ensuring reliability and efficiency. Tokenization techniques are employed to enhance system security and streamline operations, with solutions tailored to specific use cases. Encryption methods, such as GNU PG, are utilized to safeguard data integrity while allowing multiple authorized parties to access encrypted packages. Additionally, the system is configured to handle stranded devices effectively, enabling communication tunneling through mobile phones to ensure uninterrupted operation and accessibility.

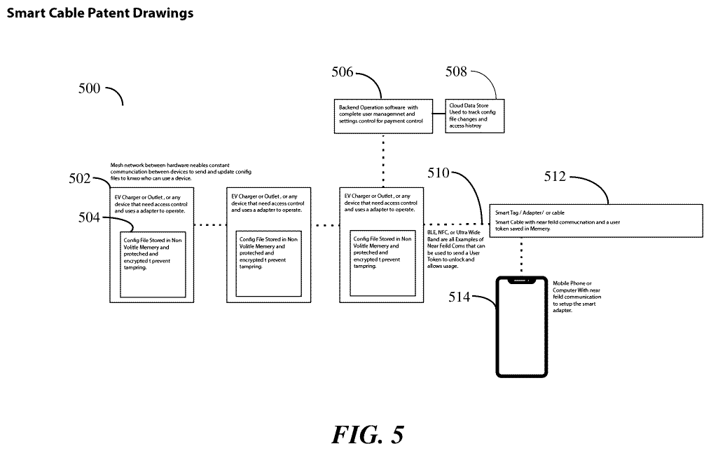

FIG. 5 is a diagram of an example process 500 to facilitate secure communication and operation of a device that requires access control and use adapters to operate. In implementations, an EV charger and/or an outlet using the smart plug, of FIG. 1, may be implemented at the outlet assembly for EV charging. At block 502, the system involves one or more devices, such as, an EV charger and/or an outlet that requires access control and use adapters to operate. A mesh network between the hardware components enables constant communication to send and update configuration files, ensuring that only authorized users can access the devices. In implementations, a plurality of EV chargers and/or outlets are electrically connected to each other in a mesh network architecture. This interconnected structure enables constant communication between devices, allowing them to send and/or update configuration files. At block 504, the system is configured for configuration files to be stored in non-volatile memory. This memory is configured to retain data even when the device is powered off, ensuring the persistence of configuration information. To safeguard these files from unauthorized access and tampering, protection and encryption protocols are applied. This security measure is consistently implemented across multiple devices within the network, providing a uniform and reliable defense against potential security threats.

At block 506, the backend operation software facilitates user management and settings control, including payment control. At block 508, a cloud data store tracks configuration file changes and access history. This centralized data repository enables real-time monitoring and auditing of system modifications, enhancing both transparency and security within the network. At block 512, a smart tag, a smart adapter, and/or a smart cables may be configured to store one or more user tokens in a memory. At block 514, the smart cable, for example, may be employed using a mobile phone and/or a computer equipped with NFC. This integrated approach ensures secure and authorized usage of EV charging infrastructure. In implementations, the smart cable, for example, may incorporate Bluetooth Low Energy (BLE), Near Field Communication (NFC), and/or Ultra-Wideband (UWB) technologies 510 to facilitate the user token verification and allow device usage.

In implementations, the store and forward principle operates by continuously updating the system's transaction identifiers to ensure security and efficiency. Specifically, each time the system reads and authenticates an identifier stored on the chip, the server generates and assigns a new identifier to replace the original one, preparing it for the subsequent transaction. This dynamic updating process is an integral part of the store and forward mechanism, which also involves transmitting one or more potential identifiers, from the server, to be stored in a database at one or more local charging stations. These operations are conducted locally, without the immediate involvement of cloud servers, thereby enhancing response times and reducing dependency on remote connectivity. The cloud server is updated retrospectively, only when a connection becomes available, ensuring that the system remains functional even in the absence of immediate cloud access. Furthermore, the generation of identifiers is performed in a distributed manner, tailored to the specific client, thus reinforcing the security and uniqueness of each transaction within the network. In an example, a subset of identifiers is associated with individual clients and/or particular smart plugs assigned to the client. These identifiers are stored within a database at one or more charging stations located in proximity to the smart plug. Upon the detecting and the authenticating of the smart plug, the charging station accesses this localized subset of identifiers at the database to retrieve and replace exhausted and/or previously validated identifiers. This localized storage approach ensures that each transaction can be accurately attributed to the correct client and smart plug, facilitating efficient and secure operations within the charging network.

In implementations, the smart EV charging system employs an identity provider and authentication mechanism to enable the usage of the system across various applications and/or loads, such as in-line EV charging, mobility charging, aquatic (boats), personal electronics charging, and equipment utilization, all of which require a device with a corresponding authentication and management system. The objective is to authenticate a charging piece of hardware to a specific profile or user to initiate or end a charging session, ensuring proper attribution of access controls, billing, payments, and energy tracking. Activation can be achieved through proximity-based wireless protocols like NFC, BLE/Bluetooth, Wi-Fi, UWB, or future wireless connectivity protocols. Alternatively, activation can occur via wired protocols, including powerline communication, or by directly plugging in. Non-powered adapters connected to a mobile connector can passively communicate through wireless protocols or direct physical connections. Powered adapters, such as NACS (J3400), J1772, Type 2, CCS, etc., can use batteries or capacitors for energy storage to enable activation and authentication. These adapters can authenticate sessions, pair with users via a website or mobile phone, and update security information for user-specific authentication.

Furthermore, the system supports authentication from a vehicle's system to the adapter, enabling functions such as adding or removing adapters from accounts, locating lost adapters, transferring adapters between users, assigning permissions, and blacklisting adapters. The adapter can store data, set charging preferences (e.g., start/stop times, energy limitations, energy price preferences), and manage energy consumption and direction from the vehicle to the building. The adapter operates with both powered and unpowered technology stacks, functioning like a credit card for user accounts to activate charge sessions within a network or across networks adopting the standard, eliminating the need for a mobile app for each authentication and session initiation. Authentication involves pairing with a backend system to ensure secure and accurate user and device validation.

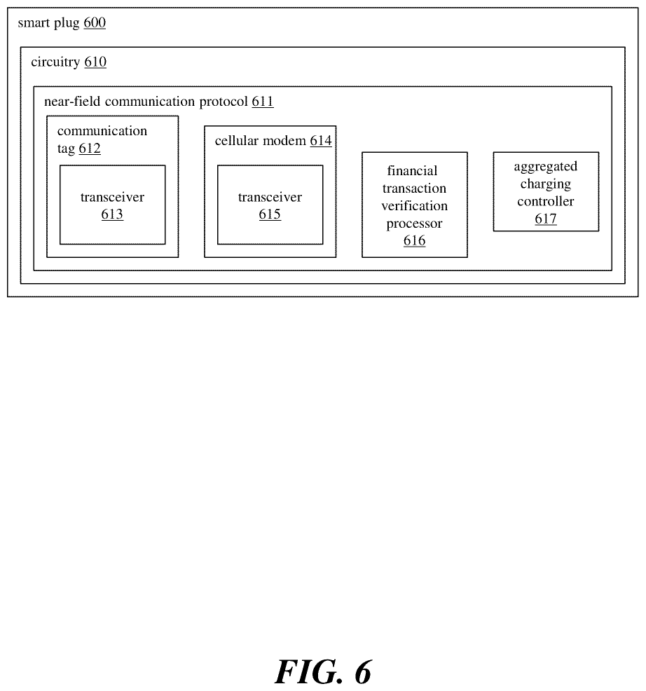

With reference to FIG. 6, the smart plug 600 is configured to interface with one or more electrical loads, such as an electric vehicle, and is designed to be removably coupled to such loads via a plug-and-play mechanism. The smart plug 600 is also configured to be electrically connected to a power source, which may be part of or connected to a charging station capable of supplying regulated charging current. Housed within the smart plug 600 is circuitry 610, which incorporates a near-field communication protocol 611 for enabling secure and localized data exchange. The near-field communication protocol 611 includes a communication tag 612 integrated into the smart plug 600. The communication tag 612 contains a transceiver 613, which is configured to transmit a wireless signal to a corresponding communication tag reader transceiver located at the charging station. This communication enables proximity detection and secure device pairing.

Additionally, the circuitry 610 includes a cellular modem 614 with a transceiver 615, which establishes a wide-area communication link with a remote server. This cellular communication allows real-time exchange of user account data, authentication requests, and status updates independent of Wi-Fi or local infrastructure. A financial transaction verification processor 616 is also electrically connected to the server and is configured to validate one or more payment authorizations or subscription credentials prior to enabling access to charging power. This component ensures that the charging session can only proceed if proper financial verification is achieved.

An aggregated charging controller 617 is also included in the circuitry 610 and is configured to manage load coordination across multiple users and devices. The aggregated charging controller 617 generates a first identifier uniquely associated with the smart plug 600. This identifier is transmitted to the server and used to verify the authenticity of the device, its user, and its pairing with a specific charging station. The identifier may be dynamically updated or replaced in future embodiments to enhance security and session tracking. The configuration shown in FIG. 6 allows for secure, automated, and app-less operation of a smart EV charging workflow. The smart plug 600, through its embedded components, not only facilitates physical power delivery but also serves as a digital interface for identity management, transaction authorization, and session control, enabling scalable deployment across public or private charging infrastructures.

The disclosed smart plug system provides several technical benefits over conventional electric vehicle charging architectures. First, by integrating a near-field communication protocol with a transceiver-enabled communication tag, the system enables secure proximity-based device authentication without requiring physical contact or user intervention, reducing latency and enhancing user convenience. The inclusion of a cellular modem with a dedicated transceiver allows for persistent, wide-area communication with a centralized server, enabling remote verification, session tracking, and interoperability across different charging networks without reliance on Wi-Fi or mobile applications. The financial transaction verification processor provides a localized, hardware-embedded mechanism for authorizing payments or subscriptions, improving transaction security and minimizing dependence on third-party applications. Moreover, the aggregated charging controller generates a unique identifier associated with the smart plug, enabling real-time validation of user and device authenticity, and allowing for dynamic management of access rights and load distribution across multiple users. This identifier system supports secure charging sessions even under changing environmental or network conditions. Collectively, these components solve technical problems related to unauthorized access, identity spoofing, and network dependency in charging ecosystems. They also reduce infrastructure complexity by consolidating communication, authentication, and transaction logic within the smart plug itself, thereby enabling scalable and app-less deployment in distributed EV charging environments.

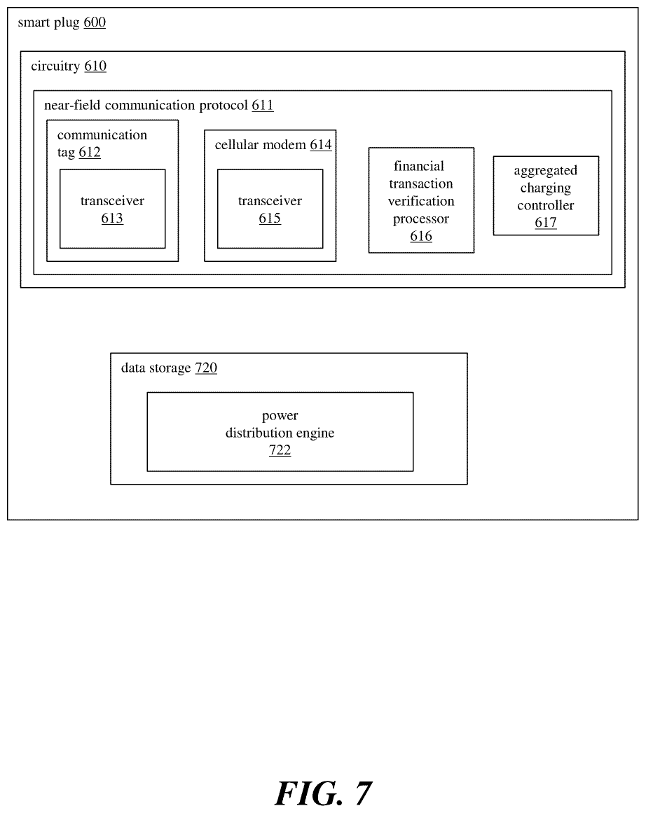

With reference to FIG. 7, the smart plug 600 is configured to be removably connected to one or more electrical loads and is electrically connected to a power source that interfaces with a charging station. The smart plug 600 comprises circuitry 610 that includes a near-field communication protocol 611 having components as previously described in FIG. 6, namely a communication tag 612 with a transceiver 613, a cellular modem 614 with a transceiver 615, a financial transaction verification processor 616, and an aggregated charging controller 617. In addition to the components of FIG. 6, FIG. 7 illustrates an electrical connection between the circuitry 610 and one or more data storage units 720. The data storage 720 contains a power distribution engine 722, which is operatively configured to interface with a remote server. The server, under the control of the power distribution engine 722, is responsible for managing power distribution to the associated charging station.

The operation of the power distribution engine 722 is contingent on three verification steps. First, the aggregated charging controller 617 verifies the authenticity of a first identifier generated for the smart plug 600. Second, the system confirms proximity between the smart plug 600 and the charging station by identifying a valid pairing between the communication tag 612 of the smart plug and a corresponding communication tag reader at the charging station. Third, the financial transaction verification processor 616 verifies that a valid financial transaction, such as a payment authorization or subscription validation, has been completed. Upon successful completion of these verifications, the server, through the power distribution engine 722, initiates the delivery of power from the charging station to the one or more loads connected to the smart plug 600. This configuration provides a secure and automated workflow that enables authenticated and transaction-verified charging without requiring direct user input, mobile applications, or physical identifiers beyond the integrated components of the smart plug system.

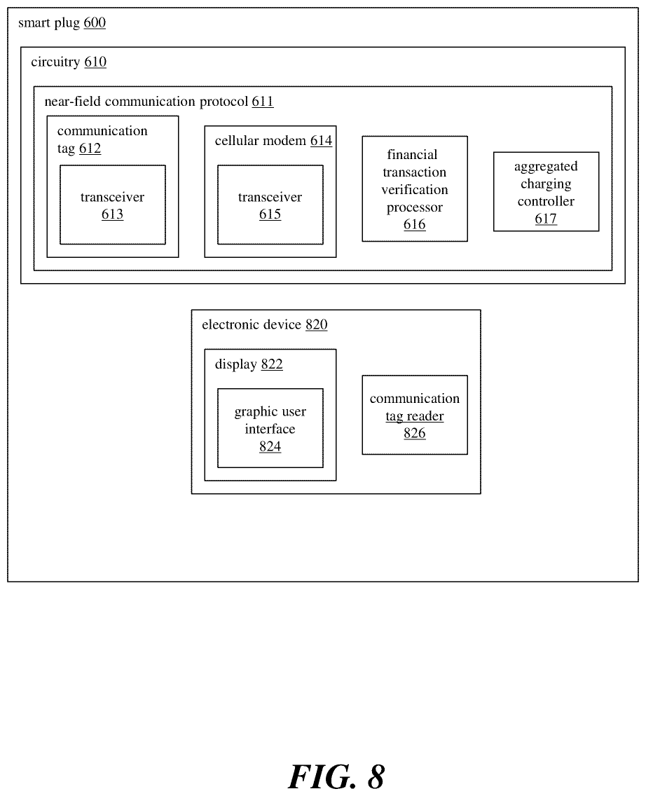

Referring to FIG. 8, a smart plug 600 is shown comprising circuitry 610 that includes a near-field communication protocol 611. The near-field communication protocol 611 comprises a communication tag 612 with a transceiver 613, a cellular modem 614 with a transceiver 615, a financial transaction verification processor 616, and an aggregated charging controller 617. The aggregated charging controller 617 is configured to generate a first identifier associated with the smart plug 600. Upon verification of the first identifier, such as through proximity-based authentication or transaction validation, the aggregated charging controller 617 is further configured to dynamically generate a second identifier. The second identifier is different from the first identifier and replaces it following successful verification. Both the first and second identifiers are generated based on one or more environmental parameters, such as geolocation, ambient temperature, time of day, or proximity of a known charging station, thereby enhancing the security and session specificity of the smart plug's operation.

The embodiment of FIG. 8 further includes an electronic device 820 associated with the smart plug 600. The electronic device 820 comprises a display 822 including a graphic user interface 824 and a communication tag reader 826. The communication tag reader 826 is configured to wirelessly pair with the communication tag 612 of the smart plug 600 using a near-field communication signal. Upon pairing, a secure connection is established between the electronic device 820 and a remote server, allowing for command transmission, user interaction via the graphic user interface 824, and execution of server-side functions such as registration, authentication, and access control. This configuration enables secure, dynamic user-device interactions in EV charging workflows, where the smart plug can authenticate and re-authenticate itself using environment-specific credentials, and users can interface with the system through the electronic device without requiring a dedicated mobile application.

The disclosed system provides technical benefits by enhancing authentication security and operational adaptability through dynamic identifier generation. In some embodiments, the aggregated charging controller generates a second identifier to replace the first identifier after verification, with both identifiers based on environmental parameters such as location, time, or proximity. This dynamic replacement mitigates replay attacks and reduces risk of spoofing, thereby improving the integrity of charging authorization. Additionally, the integration of a communication tag reader within an electronic device, paired with a graphic user interface, enables secure, app-less server connection and user interaction, reducing latency and eliminating the need for specialized software installations. These features collectively improve system scalability, user accessibility, and cybersecurity in electric vehicle charging environments.

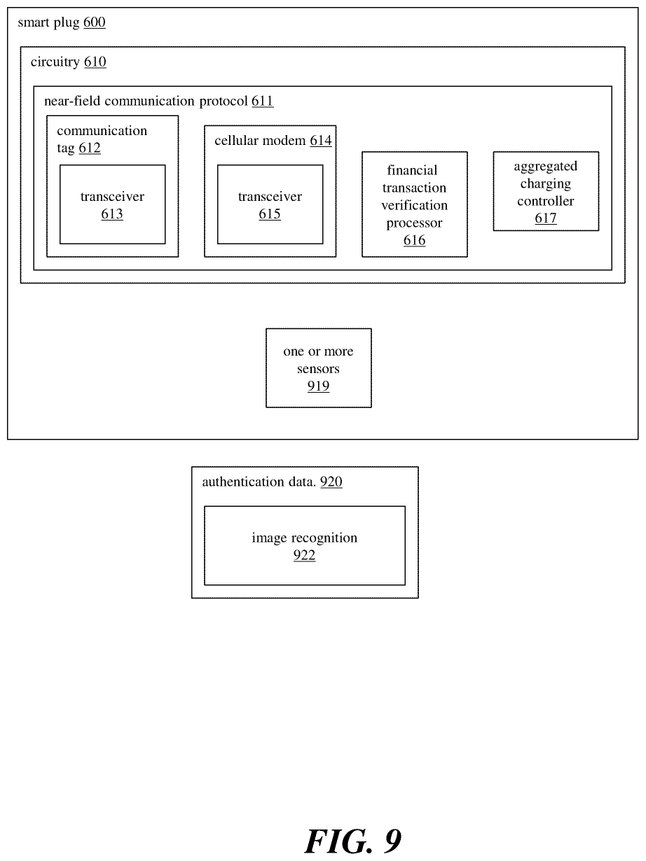

With reference to FIG. 9, an embodiment of a smart plug 600 is depicted comprising circuitry 610. The circuitry 610 includes a near-field communication protocol 611 operatively configured to facilitate proximity-based authentication and remote server communication. The near-field communication protocol 611 comprises a communication tag 612 including a transceiver 613 configured to transmit and receive signals to and from a communication tag reader disposed within a charging station or electronic device. The protocol 611 further comprises a cellular modem 614 including a transceiver 615, the cellular modem 614 being in bidirectional electrical communication with a remote server over a wireless communication network, such as LTE, 5G, or other cellular infrastructure. Additionally, the circuitry 610 includes a financial transaction verification processor 616 configured to interface with the remote server for executing authentication routines related to payment validation, subscription entitlement, or authorized user access. An aggregated charging controller 617 is electrically coupled to the financial transaction verification processor 616 and the server, and is configured to manage charging authorization protocols, including identifier generation, pairing validation, and access state determination.

The smart plug 600 further comprises one or more sensors 919, which may include optical sensors, image capture devices (e.g., cameras), LIDAR, facial recognition sensors, or vehicle identifier readers. The one or more sensors 919 are operatively configured to generate authentication data 920 representative of physical or biometric characteristics associated with a user or load. In the illustrated embodiment, the authentication data 920 includes image recognition data 922, such as facial imagery of a user or visual features of a vehicle, including license plate, color, shape, or manufacturer insignia. The authentication data 920 is transmitted via the cellular modem 614 to the server for processing. The server is configured to analyze the received authentication data 920 to determine a user status. If the server determines that the image recognition 922 matches a previously stored user profile or load credential associated with a registered user, the server transitions the user status to a “registered” state. In response to determining the user status as registered, the server transmits an authorization signal to enable unrestricted operation of the charging station. This includes activation of full-power distribution from the charging station to the one or more loads electrically connected to the smart plug 600.

If the server determines that the authentication data does not correspond to any stored registered profile, or if the image recognition 922 fails to meet a threshold matching criterion, the user status is classified as “unregistered.” In response to detecting an unregistered status, the server transmits an instruction to enable restricted operation of the charging station. The restricted operation may include one or more of: limiting electrical current to the load, enabling only a predefined charging duration, disabling certain user interface functions, or prompting the user to complete a registration process via a connected display. This architecture enables dynamic, sensor-driven access control for EV charging infrastructure, eliminating the need for external identification tools or mobile applications. The integration of onboard sensing components, real-time image recognition, and server-mediated logic allows for high-assurance, adaptive authorization of users and equipment, thereby addressing technical challenges associated with secure access, spoof resistance, and transaction integrity in decentralized charging environments.

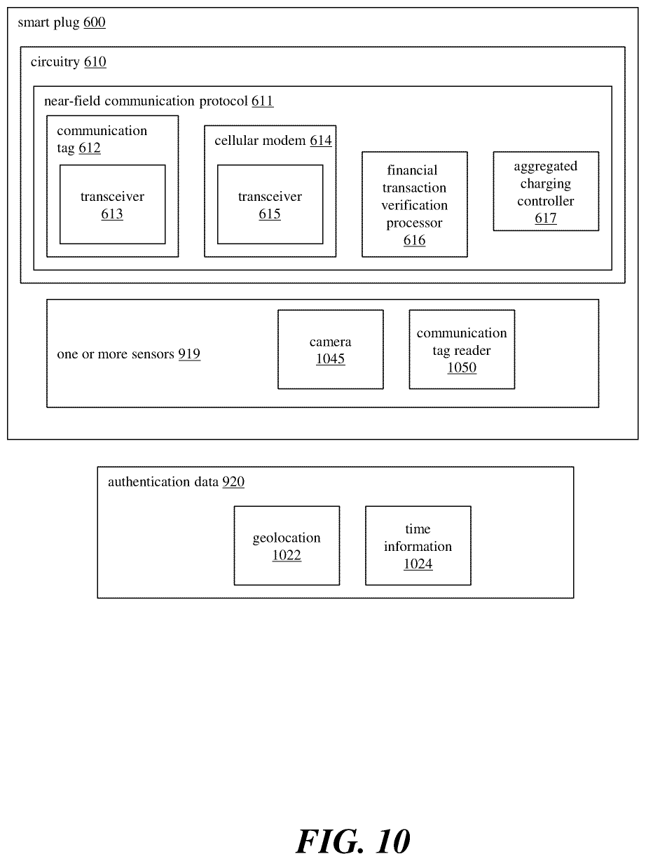

With reference to FIG. 10, an embodiment of a smart plug 600 is shown comprising circuitry 610 configured to facilitate authentication, communication, and access control functions in an electric vehicle (EV) charging context. The circuitry 610 includes a near-field communication protocol 611 comprising a communication tag 612 including a transceiver 613, a cellular modem 614 having a transceiver 615, a financial transaction verification processor 616, and an aggregated charging controller 617. These components collectively facilitate wireless communication with a remote server, validation of financial authorization, and generation of one or more identifiers associated with the smart plug 600.

The smart plug 600 further comprises one or more sensors 919, which may include, for example, a camera 1045 and a communication tag reader 1050. The camera 1045 is configured to detect an electric vehicle identifier, such as a license plate number, QR code, or other vehicle-specific image data. The communication tag reader 1050 is electrically connected to the server and configured to detect a signal emitted from an electric vehicle communication tag using a transmitter embedded within the electric vehicle communication tag. The communication tag reader 1050 includes a transceiver configured to receive the transmitted signal, such that the signal uniquely identifies the electric vehicle attempting to access the charging service. Authentication data 920 is generated by the sensors and transmitted to the server via the cellular modem 614. The authentication data 920 includes geolocation data 1022 and time information 1024, which are used in combination with the detected vehicle identifier or communication tag data to validate user identity and charging authorization. The server receives the electric vehicle communication tag and performs a lookup operation to determine whether the tag matches a previously registered communication tag associated with a user profile.

If a match is identified, the server updates the user status as “registered” and proceeds to authorize unrestricted charging access. If no match is found or the received tag data is unrecognized, the user is classified as “unregistered,” and the server may enforce restricted operation or trigger a registration workflow. This embodiment addresses technical challenges associated with unauthorized access and enhances security through use of passive tag recognition and sensor-based contextual data (location and time). The integration of a communication tag reader configured to detect low-power EV tag transmissions provides reliable, app-less authentication and reduces system dependency on manual inputs or user-carried devices, thereby improving operational efficiency, scalability, and anti-spoofing robustness in EV charging networks.

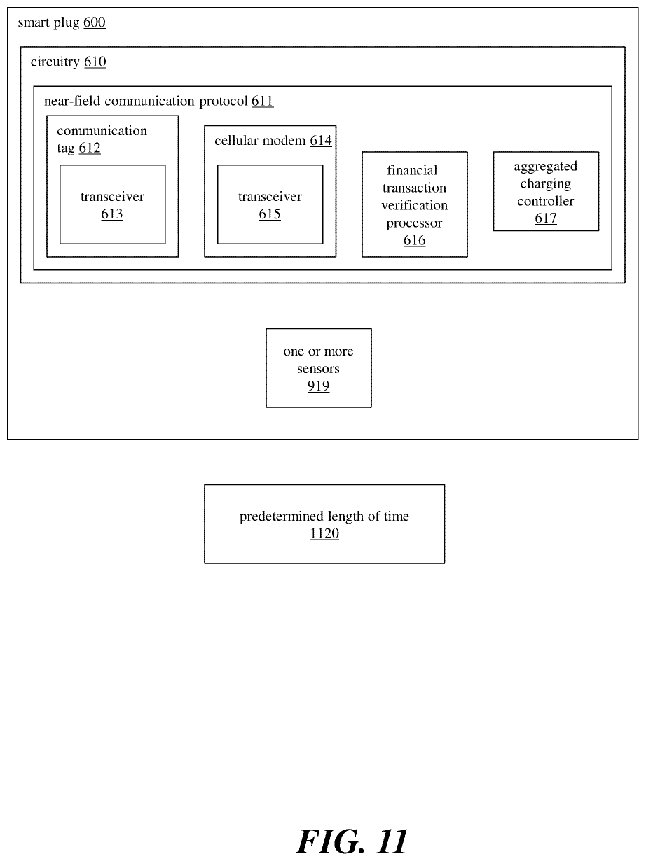

With reference to FIG. 11, a smart plug 600 is illustrated comprising circuitry 610 and one or more sensors 919 configured to enable authentication-based control over access to a charging station. The circuitry 610 includes a near-field communication protocol 611 comprising a communication tag 612 with a transceiver 613, a cellular modem 614 with a transceiver 615, a financial transaction verification processor 616, and an aggregated charging controller 617. The near-field communication protocol 611 enables proximity detection and network communication with a remote server for the purpose of identity verification, session authorization, and transaction management. The one or more sensors 919 are operatively configured to detect user input, presence, or identifiers that produce authentication data used by the server to determine a user status as either registered or unregistered. In response to detecting an unregistered user status, the server is configured to authorize restricted operation of the charging station.

As shown in FIG. 11, the restricted operation includes granting single-use access to the charging station for a predetermined length of time 1120. The predetermined length of time 1120 may be defined by the server based on system policy, local regulations, usage frequency, or sensor-derived contextual data (e.g., time of day, geographic location, or power availability). The single-use access allows a non-registered user to temporarily utilize the charging infrastructure while enforcing limitations on session duration, thereby reducing misuse or unauthorized prolonged occupancy of charging resources. This embodiment provides a technical solution for managing equitable access and controlled use of charging stations in public or shared environments. By integrating sensor-based user detection with time-restricted charging logic, the system enables limited but functional access to unregistered users while preserving system integrity, reducing congestion, and incentivizing full registration for expanded capabilities.

In further embodiments, the restricted operation includes access to a graphical user interface (GUI) rendered on a display. In one variation, the GUI is provided on a display integrated into the charging station itself. The display is configured to present an interactive interface through which the unregistered user may input profile data, such as name, contact information, vehicle identifier, and consent to terms of service. This data is transmitted to the server, which then processes the information to determine whether the user status should be updated from unregistered to registered, thereby enabling future unrestricted access.

In another variation, the GUI is rendered on a display of an electronic device, such as a smartphone, tablet, or portable computing terminal. The communication between the electronic device and the smart plug or charging station may occur through the communication tag 612 and/or cellular modem 614, enabling wireless session pairing and user onboarding. The display interface on the electronic device is similarly configured to accept input of profile data by the unregistered user, which is transmitted to the server for real-time registration status evaluation and update. These embodiments collectively provide a secure and flexible mechanism for managing restricted access in a charging environment. The inclusion of time-limited sessions and GUI-based onboarding facilitates controlled access for transient or first-time users, while promoting voluntary user registration and reducing administrative friction. The combination of embedded sensing, proximity verification, and dynamic user interface activation addresses technical challenges related to user onboarding, security, and resource fairness in public or distributed EV charging networks.

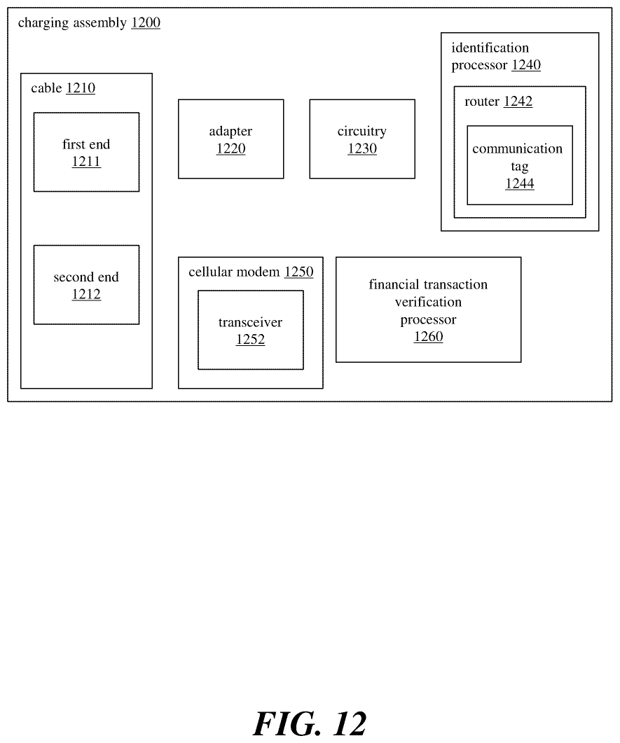

With reference to FIG. 12, an embodiment of a charging assembly 1200 is illustrated. The charging assembly 1200 includes a cable 1210 having a first end 1211 and a second end 1212. The first end 1211 of the cable 1210 is configured for physical and electrical connection to a charging unit or charger. The second end 1212 is connected to an adapter 1220, which is configured to engage with one or more electrical loads, such as an electric vehicle, storage module, or other power-receiving device. The cable 1210 is operable to transmit electrical power from the charger to the one or more loads via the adapter 1220. The charging assembly 1200 further comprises circuitry 1230 disposed at any suitable location along the cable 1210, adapter 1220, or integrated housing. The circuitry 1230 includes an identification processor 1240 comprising a router 1242 and a communication tag 1244. The communication tag 1244 is configured to emit a signal, such as a near-field communication (NFC) or radio-frequency identification (RFID) signal, which is used to uniquely identify the charging assembly 1200. The communication tag 1244 operates in conjunction with a communication tag reader associated with the charger to establish secure pairing between the charging assembly 1200 and the charger when the signal is received by the reader's transceiver.

The circuitry 1230 also includes a cellular modem 1250 comprising a transceiver 1252 configured to enable bidirectional communication between the charging assembly 1200 and a remote server over a cellular network. The modem 1250 supports asynchronous data transmission, including authentication requests, session tracking, and transaction data exchange. In addition, the circuitry 1230 comprises a financial transaction verification processor 1260 electrically connected to the server. The processor 1260 is configured to process one or more forms of financial validation, such as mobile wallet credentials, subscription verification, or micropayment authorization, prior to the initiation of charging.

The integrated identification processor 1240 and associated communication tag 1244 enable the charging assembly 1200 to be electronically identified and authenticated by the charger prior to or during a charging session. Upon successful pairing, and once the server validates the financial transaction via the processor 1260, the server may issue a charging enablement signal to allow power delivery through the cable 1210 to the one or more connected loads. This configuration enables a secure, intelligent, and portable charging solution with embedded communication and payment validation capabilities. By embedding the identification and transaction components within the charging assembly itself, the invention facilitates flexible deployment across various charger types and environments, supporting both user-specific access and infrastructure interoperability.

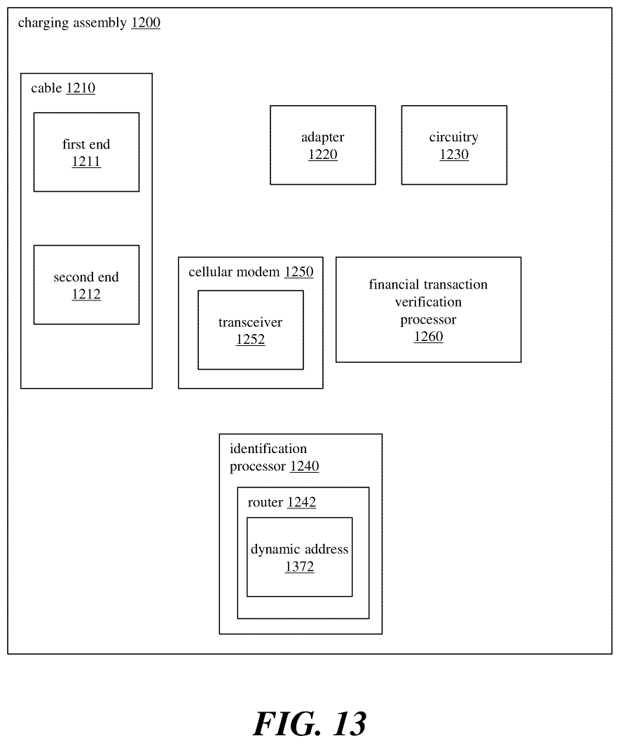

With reference to FIG. 13, an embodiment of a charging assembly 1200 is shown comprising a cable 1210 having a first end 1211 configured for electrical coupling to a charger and a second end 1212 configured to connect to one or more loads, such as an electric vehicle, through an adapter 1220. Circuitry 1230 is disposed along or within the cable or adapter and is configured to manage internal communication, load validation, and session authentication. The charging assembly 1200 further includes a cellular modem 1250 with a transceiver 1252 for establishing network communication with a remote server. A financial transaction verification processor 1260 is electrically coupled to the server and configured to validate transaction credentials, such as payment, account balance, or subscription authorization, prior to enabling power delivery. An identification processor 1240 is integrated into the assembly, and comprises a router 1242. The router 1242 is operatively configured to establish a communication session with a network coordinator, which may be part of the charging infrastructure or a distributed network manager. Upon initiation of communication, the network coordinator generates and assigns a dynamic address 1372 to the router 1242.

The dynamic address 1372 is a temporary network address that enables addressability and communication routing within a session-specific or region-specific network domain. Unlike static IP addresses, which are fixed and manually configured, the dynamic address 1372 is assigned automatically and may change across sessions. This enables flexible, context-aware routing, efficient utilization of address space, and reduced configuration overhead in environments with many distributed charging assemblies. The network coordinator is further configured to associate the dynamic address 1372 with a first media access control (MAC) address of the identification processor 1240. The MAC address uniquely identifies the physical device and is stored in association with a registered user profile on the server. This association allows the system to attribute use of the charging assembly 1200 to the appropriate registered user and to validate access rights accordingly. Once the MAC address and dynamic address are linked, the server may determine whether the charging session is authorized and initiate secure communication with the correct charging assembly, even in environments where network topologies or IP configurations change frequently.

In some embodiments, the use of a dynamically assigned network address generated by a network coordinator and associated with a media access control (MAC) address of the identification processor provides a concrete technical improvement to the functioning of the charging system. Specifically, this configuration enables automatic device recognition, secure user association, and real-time session authorization without requiring static IP assignment or manual configuration, which are limitations of conventional systems. The dynamic address, when linked to a persistent hardware identifier (MAC address), allows the system to unambiguously associate a physical charging cable and its connected load with a registered user account, even in variable or roaming network environments.

This specific configuration solves a technological problem rooted in computer networking, namely, how to maintain secure, persistent device-user associations in a distributed charging environment with non-static address assignments. It improves the operation of the system by enabling scalable and secure network identification, session continuity, and fraud prevention through automated address resolution and authenticated pairing. The claimed invention recites specific hardware structures, such as the router, identification processor, and MAC-address-based association mechanisms, and their functional cooperation with a network coordinator to achieve the above result. As such, it is not directed to a mere abstract idea but to a practical application with a specific, substantial, and credible utility in network-based electric vehicle charging.

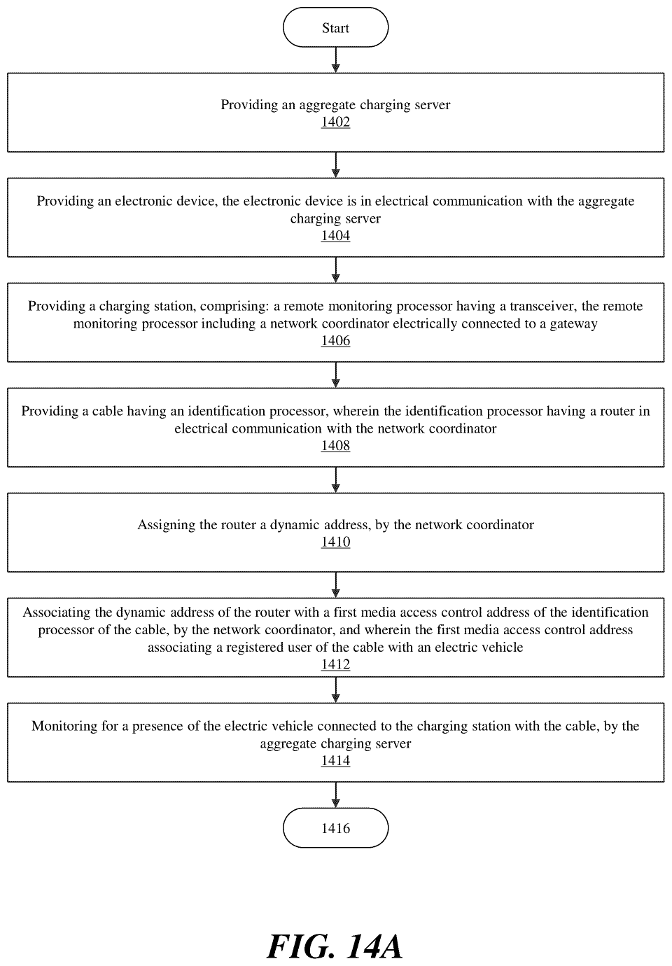

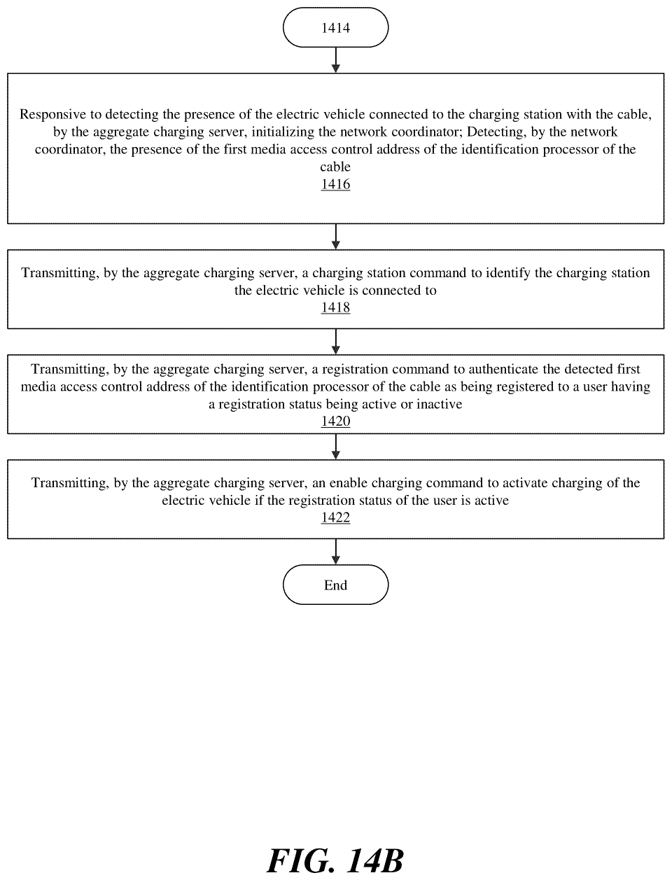

Referring to FIGS. 14A and 14B, a flowchart is shown depicting an embodiment of a computer-implemented method for enabling secure, automated electric vehicle (EV) charging using dynamic identification and authentication techniques. At block 1402, the method begins with the step of providing an aggregate charging server configured to manage networked charging transactions and session authorization. At block 1404, an electronic device is provided, wherein the electronic device is in electrical communication with the aggregate charging server. The electronic device may include a charging station interface or user-side access terminal. At block 1406, a charging station is provided, comprising a remote monitoring processor including a transceiver and a network coordinator electrically coupled to a gateway. The network coordinator is configured to assign device addresses and manage session-specific communication routing. At block 1408, a cable is provided having an identification processor, which includes a router that is in electrical communication with the network coordinator. The router enables network layer communication and discovery of the cable within the system.

At block 1410, the network coordinator assigns a dynamic address to the router. The dynamic address facilitates session-based communication while allowing the system to avoid fixed address assignment, thus supporting scalable and transient network participation. At block 1412, the dynamic address of the router is associated with a first media access control (MAC) address of the identification processor of the cable. The MAC address uniquely identifies the hardware and is associated with a registered user account linked to a specific electric vehicle. This association enables the system to track user-specific charging authorization securely across sessions and hardware instances. At block 1414, the aggregate charging server monitors for the presence of the electric vehicle connected to the charging station using the cable.

Referring now to FIG. 14B, upon detecting the presence of the electric vehicle connected to the charging station using the cable, as shown in block 1416, the aggregate charging server initializes the network coordinator, and the network coordinator detects the presence of the MAC address of the identification processor. At block 1418, the aggregate charging server transmits a charging station command to identify which charging station the electric vehicle is connected to, thereby localizing the session for subsequent authentication. At block 1420, the server transmits a registration command to authenticate the MAC address associated with the cable, determining whether the address is registered to a user with an active or inactive registration status. At block 1422, if the user registration status is determined to be active, the aggregate charging server transmits an enable charging command to activate the flow of power from the charging station to the electric vehicle.

In some embodiments, the method steps disclosed in FIGS. 14A and 14B provide a specific and practical technical solution to problems associated with dynamic identification, secure device-user association, and automated session authorization in electric vehicle (EV) charging networks. The method includes providing a cable with an embedded identification processor and router, assigning the router a dynamic address by a network coordinator, and associating that dynamic address with a static media access control (MAC) address uniquely identifying the hardware. This association forms the basis for recognizing a particular EV-user relationship at the system level. The subsequent method steps, monitoring for the presence of the EV at the charging station, detecting the MAC address, and transmitting authentication and enablement commands via an aggregate charging server, collectively enable automated, app-less charging session authorization based on verified device presence and user registration status. These method steps are not mere abstract processes but recite a series of actions performed by specifically configured components operating in a defined sequence that improves the functionality of the charging network. They enable secure, session-specific authentication without requiring manual input or fixed IP addressing, thereby enhancing scalability, network efficiency, and cyber-physical integrity. The coordinated steps solve a concrete technological problem, how to securely authorize mobile charging hardware across distributed networks, using a novel combination of dynamic addressing and hardware-level authentication.

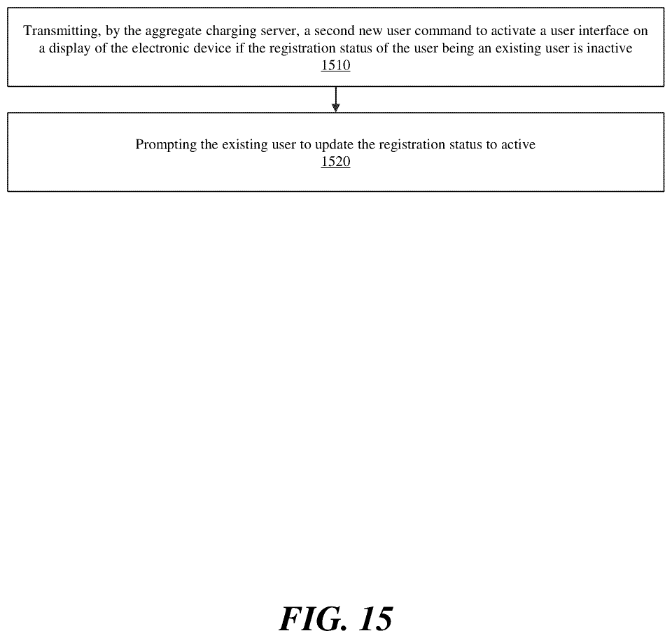

Referring to FIG. 15, a method is illustrated for updating user registration status in a networked electric vehicle (EV) charging system. The method may be implemented, for example, as a continuation of the computer-implemented method shown in FIGS. 14A and 14B. At step 1510, the aggregate charging server transmits a second new user command to activate a user interface on a display of an electronic device. The user interface may be rendered on a touchscreen display of a smartphone, tablet, vehicle infotainment system, or dedicated charging terminal. This activation step occurs when the registration status of the user, identified as an existing user in the server database, is determined to be inactive. The registration status may be based on historical charging behavior, expired credentials, or incomplete user profile data. At step 1520, the user interface prompts the existing user to update the registration status to active. The prompt may include input fields for credentials, re-authentication tokens, profile updates, or acceptance of revised terms of service. Once the necessary information is entered, the system may update the user's status in real-time, allowing full access to charging capabilities upon successful verification.

In alternative embodiments, the method may further comprise transmitting a first new user command to initiate charging for a predetermined length of time in response to identifying a first-time user with an inactive registration status. This initial access period serves as a trial or provisional session that allows the user to receive limited charging benefits while being prompted to complete registration. The illustrated steps improve user onboarding by integrating real-time prompts directly into the device interface, minimizing friction in activating a valid registration. These steps are particularly useful in environments where charging is provided without requiring pre-installed applications or accounts, enabling field-based reactivation and dynamic profile recovery.

In some embodiments, the disclosed method provides a technical improvement to electric vehicle charging systems by enabling real-time, server-initiated user status remediation through integrated user interface prompts. The system detects whether the registration status of the user is inactive and, based on that determination, automatically renders an interface for updating credentials or confirming account data, thereby reducing manual administrative interventions and enabling dynamic reauthorization. This functionality enhances the operability and responsiveness of the system by shifting registration handling to the edge (i.e., the user's device), improving scalability and minimizing downtime. The method is performed using specifically configured computing components, including a server, an electronic device with a display, and command execution protocols. It is not directed to an abstract idea but to a concrete, practical application that solves a specific problem in managing user access and continuity in EV charging systems.

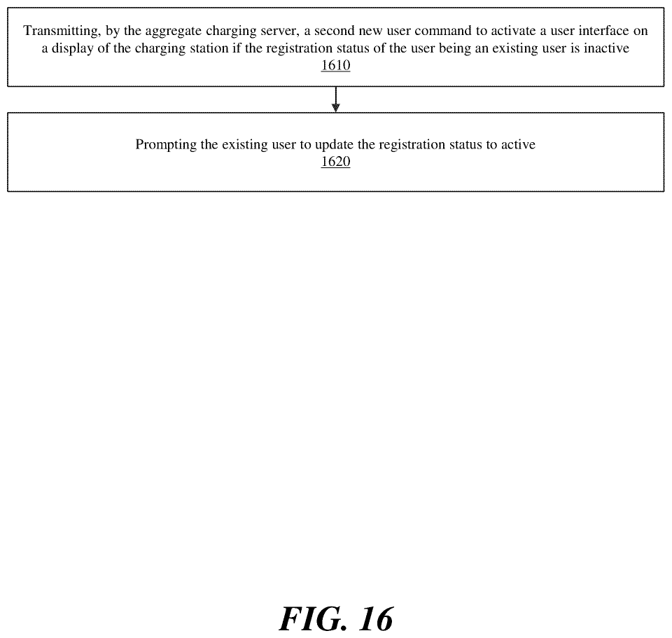

Referring to FIG. 16, a flowchart is shown representing an additional embodiment of a computer-implemented method for managing registration status of users within an electric vehicle (EV) charging infrastructure. The method may be executed by a server-based control system operating in communication with a distributed set of charging stations. At step 1610, the aggregate charging server transmits a second new user command configured to activate a user interface on a display device integrated into the charging station. This command is conditionally transmitted in response to the server determining that the registration status of the user, identified as an existing user associated with a media access control (MAC) address of a charging cable—is inactive. The display of the charging station may comprise a graphical touchscreen, LED interface, or other visual input/output component capable of rendering the user interface. At step 1620, the system prompts the existing user to update their registration status to active. The user interface may solicit profile information, authentication credentials, or other registration data. The interface may also enable direct input at the charging station itself, allowing the user to complete or renew their registration without needing a separate computing device or mobile application.

This embodiment is particularly advantageous for ensuring continuity of access for returning users whose credentials may have expired, become inactive, or require periodic renewal. It also reduces friction by leveraging the charging station hardware to complete user onboarding in situ. The steps disclosed herein improve system interoperability and usability by allowing registration remediation directly through the charging station, enhancing accessibility and reducing reliance on third-party platforms. The method leverages specifically configured computing components, namely the aggregate charging server, the charging station display hardware, and the registration status tracking subsystem, to perform real-time status evaluation and user-specific interface rendering. In some embodiments, the disclosed method provides a technical improvement to user registration handling in EV charging systems by enabling dynamic, server-initiated registration renewal directly through the charging station interface. This configuration allows existing users with inactive profiles to reactivate their status on-site, using hardware already integrated into the charging environment, thereby eliminating the need for mobile apps, external terminals, or manual backend interventions. This system-centric approach enhances the functionality of the charging infrastructure by enabling it to autonomously manage and recover user access based on context-sensitive logic. By transmitting the user command only in response to a specific registration state and rendering the interface locally, the method reduces network traffic, improves user throughput, and ensures compliance with registration rules without degrading system responsiveness.

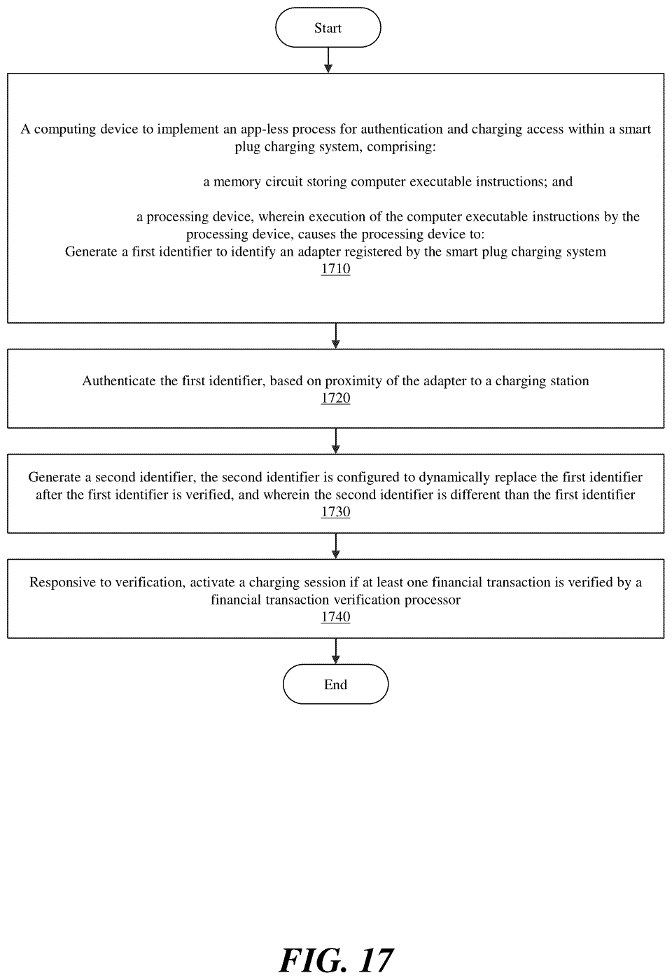

With reference to FIG. 17, a flowchart is depicted illustrating an embodiment of a computing device configured to execute a computer-implemented method for facilitating an app-less authentication and charging access process within a smart plug charging system. The computing device comprises a memory circuit configured to store computer-executable instructions and a processing device operatively coupled to the memory circuit. Upon execution of the instructions, the processing device is configured to perform a plurality of operations that enable identifier-based access control, proximity-based verification, and financial transaction validation prior to initiating a charging session. At step 1710, the processing device is configured to generate a first identifier associated with an adapter registered with the smart plug charging system. In some embodiments, the first identifier comprises a cryptographically secure token, a hashed device identifier, or a session-specific unique identifier generated using entropy sources such as temporal values, hardware MAC addresses, or environmental sensor inputs. The first identifier functions as a temporary token that uniquely associates the adapter with the current session and is stored within a secure memory of the device or transmitted to a server for downstream authentication. At step 1720, the processing device authenticates the first identifier based at least in part on proximity of the adapter to a designated charging station. In various embodiments, the authentication is facilitated using short-range wireless communication technologies such as near-field communication (NFC), Bluetooth Low Energy (BLE), or wireless transceiver protocols capable of establishing a local link between the adapter and the charging station. The proximity-based authentication ensures physical presence and mitigates risks associated with remote spoofing, unauthorized cloning, or non-local signal injection attacks.

At step 1730, the processing device is further configured to generate a second identifier. The second identifier is configured to dynamically replace the first identifier following successful verification of the first identifier. The second identifier is distinct from the first and may be generated using updated session variables, timestamping, or environmental context data such as geolocation, voltage level, or dynamic session metadata. In one embodiment, the second identifier is used to initiate a secure communication channel with the charging station or to establish a session-specific context for access control that invalidates the previous identifier, thereby preventing replay attacks. At step 1740, responsive to successful verification of the second identifier, the processing device activates a charging session if at least one financial transaction is verified by a financial transaction verification processor. The financial transaction verification processor may comprise one or more modules in communication with a payment gateway, digital wallet infrastructure, subscription management engine, or tokenized payment credential system. The processor is configured to validate the authenticity, sufficiency, and authorization status of the transaction in real-time. Only upon such verification is the charging session activated, thereby ensuring that power delivery is contingent on validated economic authorization.

This app-less computing architecture, utilizing embedded processing logic and memory-stored execution routines, enables device-level authentication and transaction processing without reliance on external user applications or manual credential entry. The identifier-based flow, in conjunction with proximity authentication and financial verification, forms a secure and automated mechanism for EV charging session control. The computing device described in this embodiment improves the operation of the charging system by enabling decentralized, application-independent control of access authorization, session initiation, and payment verification. Moreover, the method is directed to a specific and practical application of computing technology for electric vehicle charging infrastructure. It improves system performance by reducing reliance on external applications, mitigating network latency through local proximity sensing, and enhancing security through dynamic token replacement and transaction-conditional session enablement.

### Examples

Clause 1. A smart plug, comprising: the smart plug is configured to be removably connected to one or more loads; the smart plug is configured to be electrically connected to a power source, the power source is configured to be electrically connected to a charging station; and circuitry comprising: a near-field communication protocol, comprising: a communication tag, the communication tag of the smart plug has a transceiver configured to electronically communicate a signal to a transceiver of a communication tag reader of the charging station; a cellular modem, the cellular modem has a transceiver in electrical communication with a server; a financial transaction verification processor electrically connected to the server; an aggregated charging controller, the aggregated charging controller is electrically connected to the server, and

wherein a first identifier is generated by the aggregated charging controller and is associated with the smart plug.

Clause 2. The smart plug of clause 1, further comprising: one or more data storage is electrically connected to the server, the one or more data storage comprising: a power distribution engine, wherein the server is configured, by the power distribution engine, to distribute power to the charging station in response to verifying, based on proximity of the smart plug to the charging station, by the aggregated charging controller, authenticity of the first identifier of the smart plug and identifying a pairing of the communication tag reader of the charging station with the communication tag of the smart plug and verifying at least one financial transaction at the financial transaction verification processor.

Clause 3. The smart plug of clause 2, wherein the aggregated charging controller generating a second identifier, the second identifier is configured to dynamically replace the first identifier after the first identifier is verified, wherein the second identifier is different than the first identifier, and the first identifier and the second identifier are based on one or more environmental parameters.

Clause 4. The smart plug of clause 1, further comprising: an electronic device, the electronic device having a display, the display having a graphic user interface, the electronic device having a communication tag reader configured to pair with the communication tag of the smart plug to establish connection between the electronic device and the server.

Clause 5. The smart plug of clause 1, further comprising: the smart plug having one or more sensors, the server is configured to receive authentication data from the one or more sensors, wherein the server analyzes the authentication data to indicate a user status as being registered or unregistered, responsive to indicating the user status being registered, authorizing the server to distribute power from the charging station to the one or more loads, thereby allowing unrestricted operation of the charging station, and responsive to indicating the user status being unregistered, authorizing the server to distribute the power from the charging station to the one or more loads, thereby allowing restricted operation of the charging station.

Clause 6. The smart plug of clause 5, wherein the authentication data includes image recognition of a user and of the one or more loads.

Clause 7. The smart plug of clause 5, wherein the authentication data includes geolocation and time information.

Clause 8. The smart plug of clause 5, wherein the one or more sensors being a camera, the camera is configured to detect an electric vehicle identifier, wherein the server pairs the electric vehicle identifier with a user account to validate the user status as being registered if the electric vehicle identifier matches with a registered electric vehicle identifier associated with a profile of a registered user.

Clause 9. The smart plug of clause 5, wherein the one or more sensors being a communication tag reader electrically connected to the server, the communication tag reader is configured to detect an electric vehicle communication tag when a signal of the electric vehicle communication tag is transmitted, using a transmitter of the electric vehicle communication tag, to a transceiver of the communication tag reader, wherein the server is configured to pair the electric vehicle communication tag with a user account to validate the user status as being registered if the electric vehicle communication tag matches with a registered electric vehicle communication tag associated with a profile of a registered user.

Clause 10. The smart plug of clause 5, wherein the restricted operation of the charging station being a single use access having a predetermined length of time.

Clause 11. The smart plug of clause 5, wherein the restricted operation of the charging station being access to a graphic user interface of a display of the charging station, the graphic user interface of the display is configured for an unregistered user to input profile data to be processed by the server to update the user status as registered.

Clause 12. The smart plug of clause 5, wherein the restricted operation of the charging station being access to a graphic user interface of a display of an electronic device, the graphic user interface of the display is configured for an unregistered user to input profile data to be processed by the server to update the user status as registered.

Clause 13. A charging assembly, comprising: a cable with a first end, the first end of the cable is configured to connect to a charger, the cable having a second end; an adapter at the second end of the cable configured to connect to one or more loads, the cable is configured to provide power to the one or more loads from the charger; circuitry disposed at a portion of the charging assembly, the circuitry comprising: an identification processor, the identification processor having a router including a communication tag; and a cellular modem, the cellular modem having a transceiver in electrical communication with a server; a financial transaction verification processor is electrically connected to the server; and wherein the cable is coupled to the one or more loads and is configured to be detected by a communication tag reader of the charger and paired with the communication tag of the charging assembly when a signal of the communication tag is transmitted, using a transmitter of the communication tag, to a transceiver of the communication tag reader.

Clause 14. The charging assembly of clause 13, further comprising: a router is configured to be in electrical communication with a network coordinator, wherein the router having a dynamic address generated by the network coordinator, the dynamic address of the router is configured to be associated with a first media access control address of the identification processor of the cable, by the network coordinator, wherein the first media access control address is configured to associate a registered user of the cable with the one or more loads.

Clause 15. A computer-implemented method comprising: providing an aggregate charging server; providing an electronic device, the electronic device is in electrical communication with the aggregate charging server; providing a charging station, comprising: a remote monitoring processor having a transceiver, the remote monitoring processor including a network coordinator electrically connected to a gateway; providing a cable having an identification processor, wherein the identification processor having a router in electrical communication with the network coordinator; assigning the router a dynamic address, by the network coordinator; associating the dynamic address of the router with a first media access control address of the identification processor of the cable, by the network coordinator, and wherein the first media access control address associating a registered user of the cable with an electric vehicle; monitoring for a presence of the electric vehicle connected to the charging station with the cable, by the aggregate charging server; responsive to detecting the presence of the electric vehicle connected to the charging station with the cable, by the aggregate charging server, initializing the network coordinator; detecting, by the network coordinator, the presence of the first media access control address of the identification processor of the cable, transmitting, by the aggregate charging server, a charging station command to identify the charging station the electric vehicle is connected to; transmitting, by the aggregate charging server, a registration command to authenticate the detected first media access control address of the identification processor of the cable as being registered to a user having a registration status being active or inactive, wherein transmitting, by the aggregate charging server, an enable charging command to activate charging of the electric vehicle if the registration status of the user is active.

Clause 16. The computer-implemented method of clause 15, wherein responsive to transmitting the enable charging command, replacing by the network coordinator, the first media access control address of the identification processor of the cable with a second media access control address when the first media access control address has been authenticated, the second media access control address is different from the first media access control address.

Clause 17. The computer-implemented method of clause 15, further comprising: transmitting, by the aggregate charging server, a first new user command to activate charging of the electric vehicle for a predetermined length of time if the registration status of the user being a first-time user is inactive.

Clause 18. The computer-implemented method of clause 15, further comprising: transmitting, by the aggregate charging server, a second new user command to activate a user interface on a display of the electronic device if the registration status of the user being an existing user is inactive, wherein prompting the existing user to update the registration status to active.

Clause 19. The computer-implemented method of clause 15, further comprising: transmitting, by the aggregate charging server, a second new user command to activate a user interface on a display of the charging station if the registration status of the user being an existing user is inactive, wherein prompting the existing user to update the registration status to active.

Clause 20. A computing device to implement an app-less process for authentication and charging access within a smart plug charging system, comprising: a memory circuit storing computer executable instructions; and a processing device, wherein execution of the computer executable instructions by the processing device, causes the processing device to: generate a first identifier to identify an adapter registered by the smart plug charging system; authenticate the first identifier, based on proximity of the adapter to a charging station; and generate a second identifier, the second identifier is configured to dynamically replace the first identifier after the first identifier is verified, and wherein the second identifier is different than the first identifier; responsive to verification, activate a charging session if at least one financial transaction is verified by a financial transaction verification processor.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A smart plug, comprising:
the smart plug is configured to be removably connected to one or more loads;
the smart plug is configured to be electrically connected to a power source, the power source is configured to be electrically connected to a charging station; and
circuitry comprising:
a near-field communication protocol, comprising:
a communication tag, the communication tag of the smart plug has a transceiver configured to electronically communicate a signal to a transceiver of a communication tag reader of the charging station;
a cellular modem, the cellular modem has a transceiver in electrical communication with a server;
a financial transaction verification processor electrically connected to the server;
an aggregated charging controller, the aggregated charging controller is electrically connected to the server, and
wherein a first identifier is generated by the aggregated charging controller and is associated with the smart plug.

2. The smart plug of claim 1, further comprising:
one or more data storage is electrically connected to the server, the one or more data storage comprising:
a power distribution engine, wherein
the server is configured, by the power distribution engine, to distribute power to the charging station in response to verifying, based on proximity of the smart plug to the charging station, by the aggregated charging controller, authenticity of the first identifier of the smart plug and identifying a pairing of the communication tag reader of the charging station with the communication tag of the smart plug and verifying at least one financial transaction at the financial transaction verification processor.

3. The smart plug of claim 2, wherein the aggregated charging controller generating a second identifier, the second identifier is configured to dynamically replace the first identifier after the first identifier is verified, wherein the second identifier is different than the first identifier, and the first identifier and the second identifier are based on one or more environmental parameters.

4. The smart plug of claim 1, further comprising:
an electronic device, the electronic device having a display, the display having a graphic user interface, the electronic device having a communication tag reader configured to pair with the communication tag of the smart plug to establish connection between the electronic device and the server.

5. The smart plug of claim 1, further comprising:
the smart plug having one or more sensors, the server is configured to receive authentication data from the one or more sensors, wherein the server analyzes the authentication data to indicate a user status as being registered or unregistered, responsive to indicating the user status being registered, authorizing the server to distribute power from the charging station to the one or more loads, thereby allowing unrestricted operation of the charging station, and
responsive to indicating the user status being unregistered, authorizing the server to distribute the power from the charging station to the one or more loads, thereby allowing restricted operation of the charging station.

6. The smart plug of claim 5, wherein the authentication data includes image recognition of a user and of the one or more loads.

7. The smart plug of claim 5, wherein the authentication data includes geolocation and time information.

8. The smart plug of claim 5, wherein the one or more sensors being a camera, the camera is configured to detect an electric vehicle identifier, wherein the server pairs the electric vehicle identifier with a user account to validate the user status as being registered if the electric vehicle identifier matches with a registered electric vehicle identifier associated with a profile of a registered user.

9. The smart plug of claim 5, wherein the one or more sensors being a communication tag reader electrically connected to the server, the communication tag reader is configured to detect an electric vehicle communication tag when a signal of the electric vehicle communication tag is transmitted, using a transmitter of the electric vehicle communication tag, to a transceiver of the communication tag reader, wherein the server is configured to pair the electric vehicle communication tag with a user account to validate the user status as being registered if the electric vehicle communication tag matches with a registered electric vehicle communication tag associated with a profile of a registered user.

10. The smart plug of claim 5, wherein the restricted operation of the charging station being a single use access having a predetermined length of time.

11. The smart plug of claim 5, wherein the restricted operation of the charging station being access to a graphic user interface of a display of the charging station, the graphic user interface of the display is configured for an unregistered user to input profile data to be processed by the server to update the user status as registered.

12. The smart plug of claim 5, wherein the restricted operation of the charging station being access to a graphic user interface of a display of an electronic device, the graphic user interface of the display is configured for an unregistered user to input profile data to be processed by the server to update the user status as registered.

13. A charging assembly, comprising:
a cable with a first end, the first end of the cable is configured to connect to a charger, the cable having a second end;
an adapter at the second end of the cable configured to connect to one or more loads, the cable is configured to provide power to the one or more loads from the charger;
circuitry disposed at a portion of the charging assembly, the circuitry comprising:
an identification processor, the identification processor having a router including a communication tag; and
a cellular modem, the cellular modem having a transceiver in electrical communication with a server;
a financial transaction verification processor is electrically connected to the server; and wherein the cable is coupled to the one or more loads and is configured to be detected by a communication tag reader of the charger and paired with the communication tag of the charging assembly when a signal of the communication tag is transmitted, using a transmitter of the communication tag, to a transceiver of the communication tag reader.

14. The charging assembly of claim 13, further comprising:
a router is configured to be in electrical communication with a network coordinator, wherein
the router having a dynamic address generated by the network coordinator, the dynamic address of the router is configured to be associated with a first media access control address of the identification processor of the cable, by the network coordinator, wherein
the first media access control address is configured to associate a registered user of the cable with the one or more loads.

15. A computer-implemented method comprising:
providing an aggregate charging server;
providing an electronic device, the electronic device is in electrical communication with the aggregate charging server;
providing a charging station, comprising:
a remote monitoring processor having a transceiver, the remote monitoring processor including a network coordinator electrically connected to a gateway;
providing a cable having an identification processor, wherein
the identification processor having a router in electrical communication with the network coordinator;
assigning the router a dynamic address, by the network coordinator;
associating the dynamic address of the router with a first media access control address of the identification processor of the cable, by the network coordinator, and
wherein the first media access control address associating a registered user of the cable with an electric vehicle;
monitoring for a presence of the electric vehicle connected to the charging station with the cable, by the aggregate charging server;
responsive to detecting the presence of the electric vehicle connected to the charging station with the cable, by the aggregate charging server, initializing the network coordinator;
detecting, by the network coordinator, the presence of the first media access control address of the identification processor of the cable,
transmitting, by the aggregate charging server, a charging station command to
identify the charging station the electric vehicle is connected to;
transmitting, by the aggregate charging server, a registration command to authenticate the detected first media access control address of the identification processor of the cable as being registered to a user having a registration status being active or inactive, wherein
transmitting, by the aggregate charging server, an enable charging command to activate charging of the electric vehicle if the registration status of the user is active.

16. The computer-implemented method of claim 15, wherein responsive to transmitting the enable charging command, replacing by the network coordinator, the first media access control address of the identification processor of the cable with a second media access control address when the first media access control address has been authenticated, the second media access control address is different from the first media access control address.

17. The computer-implemented method of claim 15, further comprising:
transmitting, by the aggregate charging server, a first new user command to activate charging of the electric vehicle for a predetermined length of time if the registration status of the user being a first-time user is inactive.

18. The computer-implemented method of claim 15, further comprising:
transmitting, by the aggregate charging server, a second new user command to activate a user interface on a display of the electronic device if the registration status of the user being an existing user is inactive, wherein
prompting the existing user to update the registration status to active.

19. The computer-implemented method of claim 15, further comprising:
transmitting, by the aggregate charging server, a second new user command to activate a user interface on a display of the charging station if the registration status of the user being an existing user is inactive, wherein
prompting the existing user to update the registration status to active.

20. A computing device to implement an app-less process for authentication and charging access within a smart plug charging system, comprising:
a memory circuit storing computer executable instructions; and
a processing device, wherein execution of the computer executable instructions by the processing device, causes the processing device to:
generate a first identifier to identify an adapter registered by the smart plug charging system;
authenticate the first identifier, based on proximity of the adapter to a charging station; and
generate a second identifier, the second identifier is configured to dynamically replace the first identifier after the first identifier is verified, and wherein the second identifier is different than the first identifier;
responsive to verification, activate a charging session if at least one financial transaction is verified by a financial transaction verification processor.
